(19) United States
(12) Patent Application Publication
(10) Pub. No.: US 2026/0140301 A1
(43) Pub. Date: May 21, 2026

(54) MULTICORE OPTICAL FIBERS AND ELECTRONIC DEVICES COMPRISING THE SAME

(71) Applicant: CORNING INCORPORATED, CORNING, NY (US)

(72) Inventors: Kevin Wallace Bennett, Hammondsport, NY (US); Pushkar Tandon, Painted Post, NY (US)

(21) Appl. No.: 19/386,994

(22) Filed: Nov. 12, 2025

Related U.S. Application Data
(60) Provisional application No. 63/722,726, filed on Nov. 20, 2024.

(51) Int. Cl. G02B 6/02

(52) U.S. Cl. CPC G02B 6/02042; G02B 6/02028

(57) ABSTRACT

A multicore optical fiber may include a common cladding comprising a radius R₄ defining a glass portion of the optical fiber and having a cladding relative refractive index Δ₄. At least two waveguides may extend through the common cladding. Each waveguide may include a core region, an inner cladding region, and a depressed cladding region. Each core region may include a maximum relative refractive index Δ1max. Each inner cladding region may include a relative refractive index Δ₂. Each depressed cladding region may include a minimum relative refractive index Δ₃ₘᵢₙ and a trench volume from 20-45% μm² such that Δ₁ₘₐₓ>Δ₂>Δ₃ₘᵢₙ, and Δ₄>Δ₃ₘᵢₙ. A cable cutoff wavelength of each waveguide is ≤1150 nm. The co-propagating and counter-propagating inter-waveguide cross talk between each waveguide and a nearest waveguide is <−35 dB at 1310 nm and <−20 dB at 1550 nm for application lengths of 20 m. A mode field diameter of each waveguide is 8.2-9.0 μm at 1310 nm.

This application claims the benefit of priority under 35 U.S.C. § 119 of U.S. Provisional Application Ser. No. 63/722,726 filed on Nov. 20, 2024, the content of which is relied upon and incorporated herein by reference in its entirety.

### FIELD

The present specification generally relates to glass optical fibers and, more particularly, to multicore optical fibers and electronic devices comprising the same.

### TECHNICAL BACKGROUND

In recent years, optical fiber has become accepted as a viable alternative to traditional materials used for data signal communication. Optical fiber is now widely utilized in a variety of electronic systems to facilitate high-speed communication of data signals between various components. As the speed and bandwidth of digital electronic components continues to increase, so too does the need for optical fibers capable of communicatively coupling these electronic components while maintaining both the speed and bandwidth of the electronic components. Recent developments in artificial intelligence have further accelerated this need.

In conventional computing centers, data signals may be transmitted to and between the electronic devices of the computing center optically, through optical fibers. The optical signals transmitted through the optical fibers are converted to electrical signals through a transceiver and the electrical signals are transmitted from the transceiver to the electronic devices of the computing center.

As the overall package size of electronic devices continues to decrease, optical transceivers are being incorporated directly into the electronic devices. While optical fibers are suitable for providing high rates of data transmission, the reduced package size of the electronic devices may not allow conventional optical fibers to be readily coupled directly to the optical transceivers incorporated in the electronic devices to achieve the desired high data transmission rates.

Accordingly, a need exists for alternative optical fiber designs to facilitate coupling optical fibers to the transceivers of electronic devices while still allowing for relatively high data transmission rates.

### SUMMARY

According to a first aspect A1, a multicore optical fiber includes: a common cladding comprising a radius R₄ defining a glass portion of the multicore optical fiber and having a common cladding relative refractive index Δ₄; at least two waveguides extending through the common cladding, each of the at least two waveguides comprising a core region, an inner cladding region encircling and directly contacting the core region, and a depressed cladding region encircling and directly contacting the inner cladding region, wherein: the common cladding surrounds and directly contacts the depressed cladding region of each of the at least two waveguides; the radius R₄ of the common cladding is greater than or equal to 37.5 μm and less than or equal to 65 μm; the core region of each of the at least two waveguides comprises a core maximum relative refractive index Δ₁ₘₐₓ relative to pure silica glass; the inner cladding region of each of the at least two waveguides comprises an inner cladding relative refractive index Δ₂ relative to pure silica glass; the depressed cladding region of each of the at least two waveguides comprises a minimum depressed relative refractive index Δ₃ₘᵢₙ relative to pure silica glass and a trench volume V_{T} greater than or equal to 20% μm² and less than or equal to 45% μm²; Δ₁ₘₐₓ>Δ₂>Δ₃ₘᵢₙ, and Δ₄>Δ₃ₘᵢₙ; a cable cutoff wavelength of each of the at least two waveguides is less than or equal to 1150 nm; a co-propagating inter-waveguide cross talk between each of the at least two waveguides and a nearest neighbor of each waveguide is less than −35 dB at 1310 nm and less than −20 dB at 1550 nm for application lengths of 20 m; a counter-propagating inter-waveguide cross talk between each of the at least two waveguides and a nearest neighbor of each waveguide are less than −35 dB at 1310 nm and less than −20 dB at 1550 nm for application lengths of 20 m; and a mode field diameter of each of the at least two waveguides is greater than or equal to 8.2 μm and less than or equal to 9.0 μm at 1310 nm.

A second aspect A2 includes the multicore optical fiber of aspect A1, wherein the co-propagating inter-waveguide cross talk between each of the at least two waveguides and a nearest neighbor of each waveguide are less than −20 dB at 1310 nm and less than or equal to −2 dB at 1550 nm for application lengths of 1000 m.

A third aspect A3 includes the multicore optical fiber of aspect A1 or aspect A2, wherein the counter-propagating inter-waveguide cross talk between each of the at least two waveguides and a nearest neighbor of each waveguide are less than −40 dB at 1310 nm and less than −10 dB at 1550 nm for application lengths of 1000 m.

A fourth aspect A4 includes the multicore optical fiber of any preceding aspect, wherein each waveguide of the at least two waveguides comprises a zero dispersion wavelength greater than or equal to 1300 nm and less than or equal to 1324 nm.

A fifth aspect A5 includes the multicore optical fiber of any preceding aspect, wherein an attenuation of the at least two waveguides of the multicore optical fiber is less than 0.55 dB/km at a wavelength of 1310 nm.

A sixth aspect A6 includes the multicore optical fiber of any preceding aspect, wherein a macrobend loss of each waveguide of the at least two waveguides is less than or equal to 0.05 dB/turn around a 15 mm diameter mandrel at a wavelength of 1310 nm.

A seventh aspect A7 includes the multicore optical fiber of any preceding aspect, wherein a macrobend loss of each waveguide of the at least two waveguides is less than or equal to 0.005 dB/turn around a 20 mm diameter mandrel at a wavelength of 1310 nm.

An eighth aspect A8 includes the multicore optical fiber of any preceding aspect, wherein a macrobend loss of each waveguide of the at least two waveguides is less than or equal to 0.001 dB/turn around a 30 mm diameter mandrel at a wavelength of 1310 nm.

A ninth aspect A9 includes the multicore optical fiber of any preceding aspect, wherein a macrobend loss of each waveguide of the at least two waveguides is less than or equal to 0.7 dB/turn around a 15 mm diameter mandrel at a wavelength of 1550 nm.

A tenth aspect A10 includes the multicore optical fiber of any preceding aspect, wherein a macrobend loss of each waveguide of the at least two waveguides is less than or equal to 0.7 dB/turn around a 20 mm diameter mandrel at a wavelength of 1550 nm.

An eleventh aspect A11 includes the multicore optical fiber of any preceding aspect, wherein a macrobend loss of each waveguide of the at least two waveguides is less than or equal to 0.05 dB/turn around a 30 mm diameter mandrel at a wavelength of 1550 nm.

A twelfth aspect A12 includes the multicore optical fiber of any preceding aspect, wherein a waveguide-to-waveguide separation distance between each waveguide of the at least two waveguides and a nearest neighbor of each waveguide is greater than or equal to 25 μm and less than or equal to 33 μm.

A thirteenth aspect A13 includes the multicore optical fiber of any preceding aspect, wherein a web spacing between each waveguide of the at least two waveguides and a nearest neighbor of each waveguide is greater than or equal to 1.5 μm.

A fourteenth aspect A14 includes the multicore optical fiber of any preceding aspect, wherein an edge of each waveguide of the at least two waveguides is separated from an outer surface of the common cladding by a minimum waveguide edge to glass distance of greater than or equal to 8 μm.

A fifteenth aspect A15 includes the multicore optical fiber of any preceding aspect, wherein a length of the multicore optical fiber is greater than or equal to 0.5 m and less than or equal to 5 m.

A sixteenth aspect A16 includes the multicore optical fiber of any preceding aspect, wherein the common cladding is pure silica glass and the common cladding relative refractive index Δ₄ is 0%.

A seventeenth aspect A17 includes the multicore optical fiber of any of aspects A1-A16, wherein the radius R₄ is greater than or equal to 39 μm and less than or equal to 40 μm and the at least two waveguides is two waveguides.

A eighteenth aspect A18 includes the multicore optical fiber of any of aspects A1-A16, wherein the radius R₄ is greater than or equal to 62 μm and less than or equal to 63 μm and the at least two waveguides is four waveguides arranged in a 1×4 array.

A nineteenth aspect A19 includes the multicore optical fiber of any preceding aspect, further comprising a coating surrounding and directly contacting the common cladding.

A twentieth aspect A20 includes the multicore optical fiber of the aspect A19, wherein the coating has an outer coating radius R₆ greater than or equal to 80 μm and less than or equal to 125 μm.

A twenty-first aspect A21 includes the multicore optical fiber of any of aspects A19-A20, wherein a radius R₄ of the common cladding is greater than or equal to 39 μm and less than or equal to 41 μm and the outer coating radius R₆ is greater than or equal to 80 μm and less than or equal to 105 μm.

A twenty-second aspect A22 includes the multicore optical fiber of any of aspects A19-A21, wherein a radius R₄ of the common cladding is greater than or equal to 62 μm and less than or equal to 63 μm and the outer coating radius R₆ is greater than or equal to 87.5 μm and less than or equal to 105 μm.

A twenty-third aspect A23 includes the multicore optical fiber of any preceding aspect, wherein the core region of each waveguide of the at least two waveguides comprises a radius r₁ greater than or equal to 3.5 μm and less than or equal to 5 μm.

A twenty-fourth aspect A24 includes the multicore optical fiber of any preceding aspect, wherein the core maximum relative refractive index Δ₁ₘₐₓ of the core region of each waveguide of the at least two waveguides is greater than or equal to 0.30% and less than or equal to 0.40%.

A twenty-fifth aspect A25 includes the multicore optical fiber of any preceding aspect, wherein the core region of each waveguide of the at least two waveguides comprises silica glass up-doped with GeO₂ and a maximum concentration of GeO₂ in the core region is greater than or equal to 5.5 wt % and less than or equal to 7.3 wt %.

A twenty-sixth aspect A26 includes the multicore optical fiber of any preceding aspect, wherein the core region of each waveguide of the at least two waveguides comprises alpha profile with an alpha value greater than or equal to 2 and less than or equal to 20.

A twenty-seventh aspect A27 includes the multicore optical fiber of any preceding aspect, wherein the core region of each waveguide of the at least two waveguides is free of erbium and compounds of erbium.

A twenty-eighth aspect A28 includes the multicore optical fiber of any preceding aspect, wherein the core region of each waveguide of the at least two waveguides is free of optically active materials.

A twenty-ninth aspect A29 includes the multicore optical fiber of any preceding aspect, wherein the inner cladding region of each waveguide of the at least two waveguides comprises a radial thickness t₂ greater than or equal to 2 μm and less than or equal to 6.5 μm.

A thirtieth aspect A30 includes the multicore optical fiber of any preceding aspect, wherein the inner cladding relative refractive index Δ₂ of each waveguide of the at least two waveguides is greater than or equal to −0.05% and less than or equal to 0.05%.

A thirty-first aspect A31 includes the multicore optical fiber of any preceding aspect, wherein the inner cladding relative refractive index Δ₂ of each waveguide of the at least two waveguides is greater than 0% and less than or equal to 0.05%.

A thirty-second aspect A32 includes the multicore optical fiber of any preceding aspect, wherein the inner cladding region of each waveguide of the at least two waveguides is up-doped with GeO₂ and a concentration of GeO₂ in the inner cladding region is greater than 0 wt % and less than or equal to 1 wt %.

A thirty-third aspect A33 includes the multicore optical fiber of any preceding aspect, wherein the inner cladding region of each waveguide of the at least two waveguides is up-doped with Cl, and a concentration of Cl in the inner cladding region is greater than 0 wt % and less than or equal to 1.5 wt %.

A thirty-fourth aspect A34 includes the multicore optical fiber of any preceding aspect, wherein the inner cladding relative refractive index Δ₂ of each waveguide of the at least two waveguides is less than 0% and greater than or equal to −0.05%.

A thirty-fifth aspect A35 includes the multicore optical fiber of any preceding aspect, wherein the inner cladding region of each waveguide of the at least two waveguides is down-doped with F, and a concentration of F in the inner cladding region is greater than 0 wt % and less than or equal to 1.5 wt %.

A thirty-sixth aspect A36 includes the multicore optical fiber of any preceding aspect, wherein the depressed cladding region of each waveguide of the at least two waveguides comprises a radial thickness t₃ greater than 0 μm and less than or equal to 6.5 μm.

A thirty-seventh aspect A37 includes the multicore optical fiber of any preceding aspect, wherein the minimum depressed relative refractive index Δ₃ₘᵢₙ of each waveguide of the at least two waveguides is less than or equal to −0.20% and greater than or equal to −1%.

A thirty-eighth aspect A38 includes the multicore optical fiber of any preceding aspect, wherein the depressed cladding region of each waveguide of the at least two waveguides is down-doped with F, and a maximum concentration of F in the depressed cladding region is greater than or equal to 0.65 wt % and less than or equal 3 wt %.

A thirty-ninth aspect A39 includes the multicore optical fiber of any preceding aspect, wherein the trench volume V_{T} of the depressed cladding region is greater than or equal to 25% μm² and less than or equal to 40% μm².

A fortieth aspect A40 includes the multicore optical fiber of any preceding aspect, wherein a depressed relative refractive index Δ₃(r) of the depressed cladding region of each waveguide of the at least two waveguides decreases with increasing radial distance from a longitudinal centerline of each waveguide to the minimum depressed relative refractive index Δ₃ₘᵢₙ.

According to a forty-first aspect A41, an electronic device comprising: a processor circuit board comprising an application specific integrated circuit communicatively coupled to a plurality of co-packaged optical transceiver chips, wherein each co-packaged optical transceiver chip of the plurality of co-packaged optical transceiver chips comprises at least two input/output channels; and a multicore optical fiber of any of aspects A1-A40 optically coupled to each co-packaged optical transceiver chip at a first end of the multicore optical fiber, wherein each of the at least two waveguides of the multicore optical fiber is optically coupled to a corresponding input/output channel of the at least two input/output channels of each co-packaged optical transceiver chip.

A forty-second aspect A42 includes the electronic device aspect A41, wherein the electronic device comprises a shore density of greater than or equal to 1 Tbps/mm at a die edge of the processor circuit board.

A forty-third aspect A43 includes the electronic device of any of aspects A41-A42, further comprising a co-packaged optical connector optically coupling each multicore optical fiber to each co-packaged optical transceiver chip.

A forty-fourth aspect A44 includes the electronic device of any of aspects A41-A43, wherein the application specific integrated circuit is a switch application specific integrated circuit.

Additional features and advantages of the multicore optical fibers described herein will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross-sectional view of multicore optical fiber comprising at least two waveguides, specifically four waveguides, according to one or more embodiments shown and described herein;

FIG. 2 schematically depicts a cross-sectional view of a waveguide of the multicore optical fiber of FIG. 1, according to one more embodiments shown and described herein;

FIG. 3A graphically depicts an embodiment of the relative refractive index (A %) as a function of the radius (r) of a waveguide of a multicore optical fiber where the core region comprises a graded-index alpha profile according to one or more embodiments shown and described herein;

FIG. 3B graphically depicts an embodiment of the relative refractive index (A %) as a function of the radius (r) of a waveguide of a multicore optical fiber where the core region comprises a step-index alpha profile according to one or more embodiments shown and described herein;

FIG. 4A schematically depicts a cross-sectional view of an electronic device including one or more multicore optical fibers according to one or more embodiments shown and described herein;

FIG. 4B schematically depicts a top view of the electronic device of FIG. 4A; and

FIG. 5 schematically depicts a system to measure co-propagating cross talk and counter-propagating cross talk.

### DETAILED DESCRIPTION

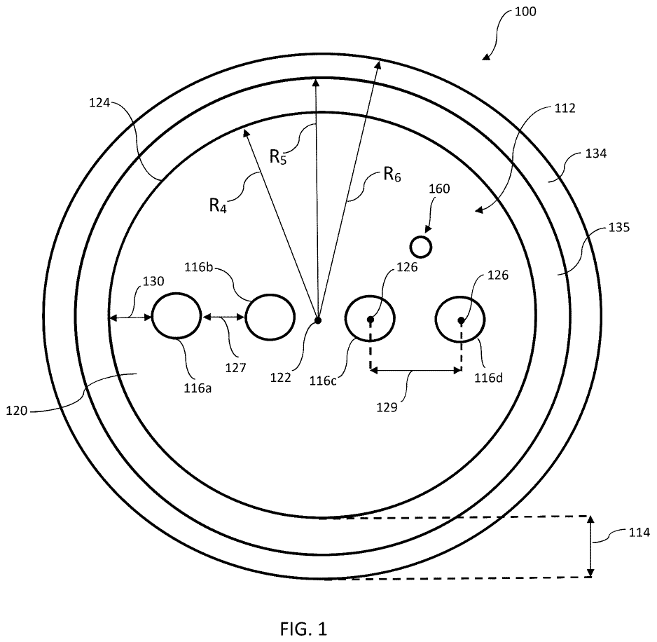

Reference will now be made in detail to embodiments of the multicore optical fibers described herein and electronic devices comprising the same, examples of which are illustrated in the accompanying drawings. Whenever possible, the same reference numerals will be used throughout the drawings to refer to the same or like parts. A cross-sectional view of one embodiment of a multicore optical fiber is schematically depicted in FIG. 1 and designated generally throughout by the reference numeral 100. In embodiments, a multicore optical fiber may include a common cladding comprising a radius R₄ defining a glass portion of the multicore optical fiber and having a common cladding relative refractive index Δ₄; at least two waveguides extending through the common cladding, each of the at least two waveguides comprising a core region, an inner cladding region encircling and directly contacting the core region, and a depressed cladding region encircling and directly contacting the inner cladding region, wherein: the common cladding surrounds and directly contacts the depressed cladding region of each of the at least two waveguides; the radius R₄ of the common cladding is greater than or equal to 37.5 μm and less than or equal to 65 μm; the core region of each of the at least two waveguides comprises a core maximum relative refractive index Δ₁ₘₐₓ relative to pure silica glass; the inner cladding region of each of the at least two waveguides comprises an inner cladding relative refractive index Δ₂ relative to pure silica glass; the depressed cladding region of each of the at least two waveguides comprises a minimum depressed relative refractive index Δ₃ₘᵢₙ relative to pure silica glass and a trench volume V_{T} greater than or equal to 20% μm² and less than or equal to 45% μm²; Δ₁ₘₐₓ>Δ₂>Δ₃ₘᵢₙ, and Δ₄>Δ₃ₘᵢₙ; a cable cutoff wavelength of each of the at least two waveguides is less than or equal to 1150 nm; a co-propagating inter-waveguide cross talk between each of the at least two waveguides and a nearest neighbor of each waveguide is less than −35 dB at 1310 nm and less than −20 dB at 1550 nm for application lengths of 20 m; a counter-propagating inter-waveguide cross talk between each of the at least two waveguides and a nearest neighbor of each waveguide are less than −35 dB at 1310 nm and less than −20 dB at 1550 nm for application lengths of 20 m; and a mode field diameter of each of the at least two waveguides is greater than or equal to 8.2 μm and less than or equal to 9.0 μm at 1310 nm. Various embodiments of multicore optical fibers and electronic devices comprising the same will be described in further detail herein with specific reference to the appended drawings.

“Radial position” and “radial distance” when used in reference to the radial coordinate “r” refer to radial position relative to the centerline (r=0) of a core region of a waveguide of the multicore optical fiber. “Radial position” and “radial distance” when used in reference to the radial coordinate “R” refer to radial position relative to the centerline (R=0) of the multicore optical fiber.

As used herein, radial position r₁ and relative refractive index Δ₁ or Δ₁(r) refer to a core region of a waveguide, radial position r₂ and relative refractive index Δ₂ or Δ₂(r) refer to an inner cladding region of a waveguide, radial position r₃ and relative refractive index Δ₃ or Δ₃(r) refer to a depressed cladding region of a waveguide, and radial position R₄ and relative refractive index Δ₄ or Δ₄(R) refer to a common cladding of the multicore optical fiber. Radial positions R₅ and R₆ refer to inner and outer coatings, respectively, of the multicore optical fiber that circumferentially surround the common cladding. Each radial position rᵢ (i=1, 2, 3) and Rᵢ (i=4, 5, 6) refers to the outer radius of the region associated with the value i. For example, r₁ refers to the outer radius of a core region of a waveguide; r₂ refers to the outer radius of an inner cladding region of a waveguide, etc.

The multicore optical fibers described herein can include at least two waveguides. Each waveguide of the multicore optical fiber comprises an outer radius r_{c}. In embodiments, the outer radius r_{c} of each waveguide corresponds to an outer radius r₃ of a depressed cladding region of that waveguide. Each waveguide is disposed within a common cladding of the multicore optical fiber, where the common cladding has a radius R₄.

The term “relative refractive index,” as used herein, is defined as:

$$Δ ( r ) \% = 100 \times \frac{( {n ( r )}^{2} - {n}_{\text{?}}^{2} )}{2 {n ( r )}^{2}} , \qquad ( \text{?} )$$

$$\text{?} \text{indicates text missing or illegible when filed}$$

where n(r) is the refractive index at radius r of the waveguide of the optical fiber, unless otherwise specified. The relative refractive index is defined at 1550 nm unless otherwise specified. In the embodiments described herein, the reference index n_{REF} is the refractive index of the common cladding. In some embodiments, the common cladding comprises pure silica glass (i.e., silica glass with an index of refraction of 1.444 at 1550 nm such that n_{REF}=1.444). Pure silica glass refers to glass that is substantially free of dopants but may comprise chlorine in concentrations of less than 1200 ppm introduced during the drying step when manufacturing the optical fiber preform from which the optical fibers are drawn. As used herein, the relative refractive index is represented by A and its values are given in units of “%” or “Δ %,” unless otherwise specified. In cases where the refractive index of a region is less than the reference index n_{REF}, the relative refractive index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative index percent is positive and the region can be said to be raised or to have a positive index.

The term “refractive index profile” or “relative refractive index profile,” as used herein, is the relationship between the refractive index or the relative refractive index and the radius of the fiber. For relative refractive index profiles depicted herein as having relatively sharp boundaries between various regions, normal variations in processing conditions appreciated in the art may result in step boundaries at the interface of adjacent regions that are not sharp. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (within a core region and/or any of the cladding regions of the waveguide and/or common cladding), it may be expressed in terms of its actual or approximate functional dependence or in terms of an average value applicable to the region. Unless otherwise specified, if the relative refractive index of a region (core region and/or any of the inner, depressed index, and/or common cladding regions) is expressed as a single value, it is understood that the relative refractive index in the region is constant, or approximately constant, and corresponds to the single value or that the single value represents an average value of a non-constant relative refractive index dependence with radial position in the region. Whether by design or as a consequence of normal manufacturing variability, the dependence of relative refractive index on radial position may be sloped, curved, or otherwise non-constant.

The term “α-profile” or “alpha profile,” as used herein, refers to a relative refractive index profile of the core region, expressed in terms of Δ which is in units of “Δ %,” which follows the equation,

$$Δ ( r ) = {Δ}_{1 max} ( 1 - {[ \frac{\vert r \vert}{\text{?}} ]}^{α} ) , \qquad ( 2 )$$

$$\text{?} \text{indicates text missing or illegible when filed}$$

where Δ₁ₘₐₓ is the maximum relative refractive index of the core region, r is the radius, r₁ is the largest radius of the core region, r is in the range rᵢ≤r≤r_{f}, Δ₁ₘₐₓ is as defined herein, rᵢ is the initial point of the α-profile, r_{f} is the final point of the α-profile, and α (also referred to as “alpha,” “α-value,” or “alpha value”) is an exponent which is a real number. In embodiments described herein, the α-value may be greater than or equal to 2 and less than or equal to 20. The term “graded-index profile” refers to an alpha profile, where α<10. The term “step-index profile” refers to an alpha profile, where α≥10. The term “parabolic profile” refers to an alpha profile, where α=2.0. The term “parabolic,” as used herein, includes substantially parabolically shaped refractive index profiles which may vary from an α-value of 2.0 at one or more points in the core portion, as well as profiles with minor variations and/or a centerline dip. In practice, in an actual multicore optical fiber, even when the target profile of the core region is an alpha profile, some level of deviation from the ideal configuration can occur. Therefore, the alpha value for an optical fiber may be obtained from a best fit of the measured index profile, as is known in the art.

The cutoff wavelength of an optical fiber is the minimum wavelength at which a waveguide of an optical fiber will support only one propagating mode. For wavelengths below the cutoff wavelength, multimode transmission may occur and an additional source of dispersion may arise to limit the optical fiber's information carrying capacity. Cutoff wavelength will be reported herein as a cable cutoff wavelength. The cable cutoff wavelength is based on a 22-meter cabled fiber length as specified in TIA-455-80: FOTP-80 IEC-60793-1-44 Optical Fibres—Part 1-44: Measurement Methods and Test Procedures—Cut-off Wavelength (21 May 2003), by Telecommunications Industry Association (TIA).

An “up-dopant” is a substance added to a glass that has a propensity to raise the refractive index relative to pure, undoped silica. A “down-dopant” is a substance added to a glass that has a propensity to lower the refractive index relative to pure, undoped silica. Examples of up-dopants include GeO₂ (germania), Al₂O₃, P₂O₅, TiO₂, Cl, Br, and alkali metal oxides, such as K₂O, Na₂O, Li₂O, Cs₂O, Rb₂O, and mixtures thereof. Examples of down-dopants include fluorine (F) and boron (B).

While the numerical aperture of the core region of a waveguide of the optical fiber may be mathematically calculated, under certain circumstances it may be necessary to experimentally determine the numerical aperture. For example, in some situations, the index of refraction of a particular portion of the optical fiber may not be precisely known. Under such circumstances the numerical aperture of the core region of a waveguide of the optical fiber may be measured using an angular measurement technique similar to that described in the article entitled “Propagation losses of pump light in rectangular double-clad fibers” by Anping Liu and Kenichi Ueda, 3134 Optical Engineering, Vol. 35 No. 11, November 1996.

The mode field diameter (MFD) of a core region of the multicore optical fiber is measured using the Petermann II method and was determined from:

$$MFD = 2 w \qquad ( 4 )$$

$$w = \frac{\text{?}}{\text{?}} \qquad ( 5 )$$

$$\text{?} \text{indicates text missing or illegible when filed}$$

where f(r) is the transverse component of the electric field distribution of the light guided in a waveguide (core region) and r is the radial coordinate of the waveguide (core region) of the fiber. The “mode field diameter” or “MFD” refers to the mode field diameter at 1310 nm or 1550 nm, unless otherwise specified.

“Chromatic dispersion,” herein referred to as “dispersion” unless otherwise noted, of a core region of the multicore optical fiber is the sum of the material dispersion, the waveguide dispersion, and the intermodal dispersion. “Material dispersion” refers to the manner in which the refractive index of the material used for the core region affects the velocity at which different optical wavelengths propagate within the core region. “Waveguide dispersion” refers to dispersion caused by the different refractive indices of the core region and claddings of the multicore optical fiber. In the case of single mode fibers, the inter-modal dispersion is zero. Dispersion values in a two-mode regime assume intermodal dispersion is zero. The zero dispersion wavelength (λ₀) is the wavelength at which the dispersion has a value of zero. Dispersion slope is the rate of change of dispersion with respect to wavelength. Dispersion and dispersion slope may be reported at wavelengths of 1310 nm and/or 1550 nm, and are expressed in units of ps/nm/km and ps/nm²/km, respectively. Chromatic dispersion is measured as specified by the IEC 60793-1-42:2013 standard, “Optical fibres—Part 1-42: Measurement methods and test procedures—Chromatic dispersion.”

The term “attenuation,” as used herein, is the loss of optical power as the signal travels along the core region of the multicore optical fiber. Attenuation is measured as specified by the IEC 60793-1-40:2019 standard entitled “Optical fibres—Part 1-40: Attenuation measurement methods.”

The bend resistance of a core region of the multicore optical fiber, expressed as “macrobend loss” or “bend loss” herein, can be gauged by induced attenuation under prescribed test conditions as specified by the IEC-60793-1-47:2017 standard, “Optical fibres—Part 1-47: Measurement methods and test procedures—Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

The term “crosstalk” in a multi-core optical fiber is a measure of how much power leaks from one core portion to another, adjacent core portion. As used herein, the term “adjacent core portion” refers to the core that is nearest to the reference core portion. In some embodiments, all core portions may be equally spaced from one another, meaning that all core portions are adjacent one another. In other embodiments, the core portions may not be equally spaced from one another, meaning that some core portions will be spaced further from the reference core portion than adjacent core portions are spaced from the reference core portion.

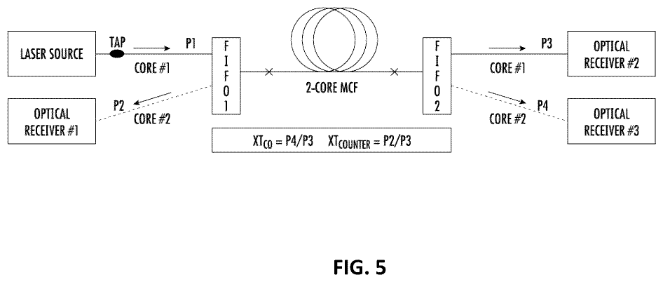

The system to measure co-propagating crosstalk and counter-propagating crosstalk, as disclosed herein, is shown in FIG. 5. In order to measure the disclosed crosstalk between adjacent core portions (e.g., as described herein, two core portions having centerlines separated by a minimum core-to-core separation distance), multicore fibers with a length between 10 m and 5 km on a standard shipping spool were tested. As shown in FIG. 5, the system comprises a tunable laser source (TLS) with a linewidth of 200 kHz, a tap to monitor the laser output power, and a multicore fiber fan-in/fan-out (FIFO 1) spliced to the fiber to inject the source light into one of two adjacent core portions of the fiber while directing backward propagating light in the other of the two adjacent core portions. A fan-out (FIFO 2) is spliced at the far end of the fiber, and its outputs are connected to optical receivers to measure forward propagating light out of each core. The optical receivers #1, #2, and #3, as shown in FIG. 5, are each a high sensitivity detector with −109 dBm noise sensitivity and linearity error with <20% deviation over the entire power measured range (+5 to −75 dBm). All three optical receivers were calibrated and read out the same power at one power level. The multicore fiber used to fabricate FIFOs had the same mode field diameter and core-to-core pitch as the transmission multicore fiber under test. Co-propagating crosstalk can then be calculated using the measured power P3 and P4, and the counter-propagating crosstalk can then be calculated using the measured P3 and P2. Further details about the measurement method and setup can be found in P. Tandon, et al., “Record Low Loss 0.144 dB/km 2-Core Optical Fiber for Submarine Transmission,” Journal of Lightwave Technology, Vol. 42, No. 12, Jun. 15, 2024, the content of which is incorporated herein by reference in its entirety.

The “effective area” of a core region of a multicore optical fiber is defined as:

$${A}_{eff} = \frac{2 {π [ {\int }_{0}^{∞} {( f ( r ) )}^{2} rdr ]}^{2}}{{\int }_{0}^{∞} ( f ( r ) ) \text{?} rdr} \qquad ( 6 )$$

$$\text{?} \text{indicates text missing or illegible when filed}$$

where f(r) is the transverse component of the electric field of the guided optical signal and r is radial position in the fiber. In some embodiment, the effective area” or “A_{eff}” depends on the wavelength of the optical signal and is understood to refer to wavelengths of 1310 nm and 1550 nm as indicated herein.

The terms “microns” and “μm” are used interchangeably herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As noted herein, in conventional computing centers, data signals may be transmitted to and between the electronic devices of the computing center optically, through optical fibers. The optical signals transmitted through the optical fibers are converted to electrical signals through a transceiver and the electrical signals are transmitted from the transceiver to the electronic devices of the computing center.

As the overall package size of electronic devices continues to decrease, optical transceivers are being incorporated directly into the electronic devices. While optical fibers are suitable for providing high rates of data transmission, the reduced package size of the electronic devices may not allow conventional optical fibers to be readily coupled directly to the optical transceivers incorporated in the electronic devices while still achieving the desired high data transmission rates. In particular, electronic devices currently in development may require data transmission densities (also referred to as “shore densities”) of at least 1 terabyte per second per millimeter (1 Tbps/mm) at the interface between the optical fiber(s) and the electronic device. This means that at least 1 Tbps of data should be delivered to the electronic device for every mm of length of the interface. Data transmission rates of at least 1 Tbps may be facilitated through the use of individual optical fibers (i.e., individual waveguides). However, current optical fiber designs may not readily provide the desired shore density due to constraints on the configuration of the waveguides in the optical fibers.

Disclosed herein are multicore optical fibers which may be used to couple optical signals into electronic devices through a plurality (i.e., at least two) waveguides. The multicore optical fibers are configured to achieve shore densities of at least 1 Tbps/mm. The multicore optical fibers may be utilized in harnesses in co-packaged optics applications used in conjunction with electronic devices.

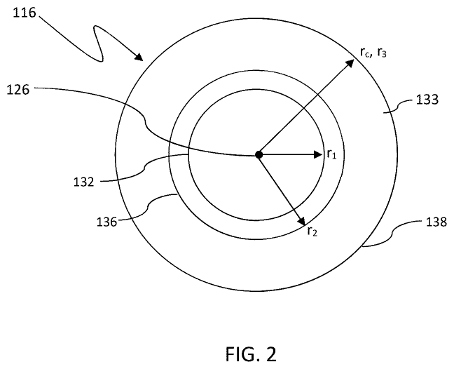

Referring now to the figures, FIG. 1 schematically depicts a cross-sectional view of a multicore optical fiber 100. According to the embodiments described herein, the multicore optical fiber 100 comprises at least two waveguides 116 (such as waveguides 116a, 116b, 116c, and 116d), each comprising a core region 132 (FIG. 2). While FIG. 1 depicts a multicore optical fiber 100 with four waveguides 116a, 116b, 116c, and 116d, it should be understood that the multicore optical fiber 100 may contain fewer than four waveguides (such as two or three waveguides) or greater than four waveguides.

In the embodiments described herein, the multicore optical fibers 100 comprise a glass portion 112 and a coating portion 114 encircling and directly contacting the glass portion 112. The glass portion 112 comprises the at least two waveguides 116, such as waveguides 116a, 116b, 116c, and 116d, and a common cladding 120. The at least two waveguides 116 are disposed in the common cladding 120. The common cladding 120 has a common cladding relative refractive index of Δ₄ and comprises a longitudinal centerline 122 (positioned at R=0). In embodiments, the common cladding 120 is formed from pure silica glass, as defined herein. In embodiments, the longitudinal centerline 122 of the common cladding 120 coincides with a longitudinal centerline of the multicore optical fiber 100. The common cladding 120 comprises an outer surface 124 circumferentially surrounding and disposed a radial distance R₄ from the longitudinal centerline 122 such that the common cladding 120 has a radius R₄. The radial distance R₄ defines a radius of the glass portion 112 of the multicore optical fiber 100. In embodiments, R₄ is less than or equal to 65 μm. For example, in embodiments, the common cladding 120 may have a radius R₄ greater than or equal to 37.5 μm and less than or equal to 65 μm, greater than or equal to 40 μm and less than or equal to 65 μm, greater than or equal to 45 μm and less than or equal to 65 μm, greater than or equal to 50 μm and less than or equal to 65 μm, or even greater than or equal to 55 μm and less than or equal to 65 μm. In embodiments, the common cladding 120 may have a radius R₄ greater than or equal to 40 μm and less than or equal to 62.5 μm, greater than or equal to 45 μm and less than or equal to 62.5 μm, greater than or equal to 50 μm and less than or equal to 62.5 μm, or even greater than or equal to 55 μm and less than or equal to 62.5 μm. In embodiments, the common cladding 120 may have a radius R₄ greater than or equal to 40 μm and less than or equal to 55 μm, greater than or equal to 40 μm and less than or equal to 50 μm, or even greater than or equal to 40 μm and less than or equal to 45 μm. In embodiments, the common cladding 120 may have a radius R₄ greater than or equal to 45 μm and less than or equal to 62.5 μm, greater than or equal to 45 μm and less than or equal to 55 μm, or even greater than or equal to 45 μm and less than or equal to 55 μm. In embodiments, the common cladding 120 may have a radius R₄ greater than or equal to 50 μm and less than or equal to 62.5 μm, greater than or equal to 50 μm and less than or equal to 57.5 μm, or even greater than or equal to 50 μm and less than or equal to 55 μm. The above ranges include all subranges within the explicitly disclosed ranges as well as ranges formed from any combination of the endpoints thereof. In embodiments, the common cladding 120 may have a radius R₄ that is greater than or equal to 39 μm and less than or equal to 40 μm and the at least two waveguides 116 is, or consists of, two waveguides (such as a 1×2 linear array of waveguides as described in further detail herein). In embodiments, the common cladding 120 may have a radius R₄ that is greater than or equal to 62 μm and less than or equal to 63 μm and the at least two waveguides 116 is, or consists of, four waveguides (such as a 1×4 linear array of waveguides as described in further detail herein).

The waveguides 116a, 116b, 116c, and 116d extend through the common cladding 120. Each of the waveguides 116a, 116b, 116c, and 116d comprises a core longitudinal centerline 126 (corresponding to r=0 for each of the waveguides 116a, 116b, 116c, and 116d). In the embodiments described herein, the waveguides 116a, 116b, 116c, and 116d are separated from one another by a waveguide-to-waveguide separation distance 129.

In the embodiments described herein, the at least two waveguides 116 are arranged in a 1×N linear array, where N is the number of waveguides in the array (i.e., N is greater than or equal to 2). More specifically, the at least two waveguides 116 are arranged such that the core longitudinal centerline 126 of each waveguide 116 in the 1×N array lies on a common line that extends orthogonal to the longitudinal centerline 122 of the common cladding 120 such that the 1×N array is linear. In embodiments, the at least two waveguides 116 are arranged such that the core longitudinal centerline 126 of each waveguide 116 in the 1×N array lies on a common line that extends orthogonal to and passes through the longitudinal centerline 122 of the common cladding 120 such that the 1×N array of waveguides 116 is linear and extends along a diameter of the multicore optical fiber 100.

In the embodiments described herein, the waveguide-to-waveguide separation distance 129 is the distance between the longitudinal centerlines of adjacent waveguides. That is, the waveguide-to-waveguide separation distance 129 is the distance between the core longitudinal centerline of one waveguide and the core longitudinal centerline of the nearest neighbor of each waveguide. In embodiments, the waveguide-to-waveguide spacing between adjacent waveguides is equidistant. In alternative embodiments, the waveguide-to-waveguide spacing between adjacent waveguides is non-uniform. That is, the spacing between waveguides varies from a particular waveguide to different adjacent waveguides. When the waveguide-to-waveguide spacing is non-uniform, it is understood that the waveguide-to-waveguide separation distance of the particular waveguide refers to the shortest distance between the longitudinal centerlines of the particular waveguide and its nearest neighbor waveguide. For purposes of illustration, the nearest neighbor of waveguide 116a is waveguide 116b. As another illustration, the nearest neighbor of waveguide 116b may be either waveguide 116a or waveguide 116c depending on which waveguide-to-waveguide spacing is shorter.

In embodiments, the waveguide-to-waveguide separation distance 129 is greater than or equal to 25.0 μm. In embodiments, the waveguide-to-waveguide separation distance 129 is less than or equal to 33.0 μm. For example, in embodiments, the waveguide-to-waveguide separation distance 129 is greater than or equal to 25.0 μm and less than or equal to 33.0 μm, greater than or equal to 25.0 μm and less than or equal to 32.0 μm, greater than or equal to 25.0 μm and less than or equal to 30.0 μm, greater than or equal to 25.0 μm and less than or equal to 28.0 μm, greater than or equal to 25.0 μm and less than or equal to 26.0 μm, or even greater than or equal to 25.0 μm and less than or equal to 25.5 μm. In embodiments, the waveguide-to-waveguide separation distance 129 is greater than or equal to 26.0 μm and less than or equal to 33.0 μm, greater than or equal to 28.0 μm and less than or equal to 33.0 μm, greater than or equal to 30.0 μm and less than or equal to 33.0 μm, greater than or equal to 31.0 μm and less than or equal to 33.0 μm, or even greater than or equal to 32.0 μm and less than or equal to 33.0 μm. The above ranges include all subranges within the explicitly disclosed ranges as well as ranges formed from any combination of the endpoints thereof. Such separation between the waveguides 116a, 116b, 116c, and 116d may facilitate a compact design for the multicore optical fiber 100 while still maintaining a co-propagating inter-waveguide cross talk between adjacent waveguides that is less than or equal to −35 dB at 1310 nm and less than or equal to −29 dB at 1550 nm at an application length of 20 meters (i.e., a length of the multicore optical fiber is 20 meters) and a counter-propagating inter-waveguide cross talk between adjacent waveguides that is less than or equal to −35 dB at 1310 nm and less than or equal to −20 dB at 1550 nm at an application length of 20 meters.

In embodiments, edges of the waveguides 116a, 116b, 116c, and 116d are separated from the outer surface 124 of the common cladding 120 by at least a minimum waveguide edge to glass edge distance 130. As depicted in FIG. 1, the minimum waveguide edge to glass edge distance 130 is the minimum distance from a point along the outer circumference of one of the waveguides 116a, 116b, 116c, and 116d (e.g., the point corresponding to the r₃ value for each waveguide, as described further herein with respect to FIG. 2) to a nearest point along the circumference of the outer surface 124 of the common cladding 120, as determined by a line segment between the point along the outer circumference of the waveguide and the nearest point along the circumference on the outer surface 124 of the common cladding 120 in a plane perpendicular to the longitudinal centerline 122 of the common cladding 120. In embodiments, the minimum waveguide edge to glass edge distance 130 is greater than or equal to 8.0 μm. In embodiments, the minimum waveguide edge to glass edge distance 130 is greater than or equal to 9.0 μm, greater than or equal to 10.0 μm, greater than or equal to 11.0 μm, greater than or equal to 12.0 μm, greater than or equal to 13.0 μm, greater than or equal to 14.0 μm, or even greater than or equal to 14.5 μm. In embodiments, the maximum waveguide to glass edge distance 130 is less than or equal to 15.0 μm, less than or equal to 14.5 μm, less than or equal to 14.0 μm, less than or equal to 13.5 μm, less than or equal to 13.0 μm, less than or equal to 12.5 μm, less than or equal to 12.0 μm, or even less than or equal to 11.5 μm. The above ranges include all subranges within the explicitly disclosed ranges as well as ranges formed from any combination of the endpoints thereof. Without intending to be bound by any particular theory, it is believed that the extent of signal loss due to tunneling of the signal to the high index coating (and thus contributing to increased attenuation of the signal) is dependent upon the minimum value for the minimum waveguide edge to glass edge distance 130, so maintaining the minimum waveguide edge to glass edge distance 130 to be greater than or equal to the values disclosed herein may minimize tunneling loss and overall attenuation while maintaining separation between the waveguides 116a, 116b, 116c, and 116d to inhibit inter-waveguide cross talk (both co-propagating and counter propagating) between the waveguides.

As depicted in FIG. 1, adjacent waveguides 116 in the common cladding 120 are separated by a web spacing 127. The web spacing 127 is the shortest distance between the radius r₃ (FIG. 2) of one waveguide and the radius r₃ of an adjacent waveguide. In the embodiments described herein, the web spacing 127 is greater than or equal to 1.5 μm, greater than or equal to 2.0 μm, greater than or equal to 2.5 μm, or even greater than or equal to 3.0 μm. The above ranges include all subranges within the explicitly disclosed ranges as well as ranges formed from any combination of the endpoints thereof. Without intending to be bound by any particular theory, it is believed that maintaining the web spacing 127 at a value greater than or equal to 1.5 μm improves the manufacturability of the multicore optical fiber 100.

In embodiments, a marker 160 may be optionally disposed in the common cladding 120, as shown in FIG. 1, to mark, for example, at least one of the at least two waveguides 116. Like the waveguides 116a, 116b, 116c, and 116d, the marker 160 extends through the common cladding 120. The marker 160 facilitates orienting the multicore optical fiber 100 during, for example, coupling of the multicore optical fiber 100 to other optical fibers and/or to electronic devices, such as optical transceivers and the like. For example, marker 160 may be used to identify the relative location of a “first waveguide” within the multicore optical fiber 100, such as waveguide 116d. The other waveguides within the common cladding 120 may then be identified based upon their relative position to the “first waveguide.” Therefore, in embodiments, marker 160 is disposed in the common cladding 120 at a position to clearly identify the “first waveguide.” It is noted that a first end of the multicore optical fiber is a mirror image of the second end of the multicore optical fiber 100. As such, placing marker 160 at a centerline 122 of the multicore optical fiber 100 may not be useful to distinguish between the different waveguides. Therefore, in embodiments, marker 160 is not disposed at the longitudinal centerline 122 of multicore optical fiber 100.

In the embodiment of the multicore optical fiber 100 depicted in FIG. 1, marker 160 is disposed equidistantly between the core longitudinal centerlines 126 of two adjacent waveguides 116c, 116d such that at least one of these adjacent waveguides is an outer waveguide. Therefore, in this embodiment, the outer waveguide near marker 160 may be identified as the “first core.” However, it is also contemplated that marker 160 may be disposed in other locations within the common cladding 120 with preference given to locations that are not on a line of symmetry of the multicore optical fiber 100 so as to uniquely identify a waveguide regardless of which mirror image end of the multicore optical fiber 100 is being viewed.

Referring still to FIG. 1, the coating portion 114 of the multicore optical fiber 100 includes a primary coating 135 encircling and directly contacting the common cladding 120 and a secondary coating 134 encircling and directly contacting the primary coating 135. In embodiments, the primary coating 135 serves as a buffer to protect the glass portion 112 of the multicore optical fiber 100 when the multicore optical fiber 100 is bent, cabled, or spooled. The primary coating 135 may also serve to protect the outer surface 124 of the glass portion 112 from water absorption. The secondary coating 134 may be applied over the primary coating 135 and serves as a protective layer that prevents the glass portion 112 of the multicore optical fiber from being damaged during processing and use. The primary coating 135 has a radius R₅ and the secondary coating 134 has a radius R₆. In embodiments, R₆ defines an external radius of the multicore optical fiber 100. In embodiments the outer diameter (2*R₆) of the multicore optical fiber 100 is less than or equal to 250.0 μm (i.e., R₆ is less than or equal to 125.0 μm). In embodiments, the outer diameter (2*R₆) of the multicore optical fiber 100 is greater than or equal to 160 μm (i.e., R₆ is greater than or equal to 80.0 μm) and less than or equal to 250 μm (i.e., R₆ is less than or equal to 125.0 μm) or even greater than or equal to 160 μm (i.e., R₆ is greater than or equal to 80.0 μm) and less than or equal to 210 μm (i.e., R₆ is less than or equal to 105.0 μm). In embodiments where the radius R₄ of the common cladding is greater than or equal to 39 μm and less than or equal to 41 μm, the outer diameter (2*R₆) of the multicore optical fiber 100 may be greater than or equal to 160 μm (i.e., R₆ is greater than or equal to 80.0 μm) and less than or equal to 210.0 μm (i.e., R₆ is less than or equal to 105.0 μm). In embodiments where the radius R4 of the common cladding is greater than or equal to 62 μm and less than or equal to 63 μm, the outer diameter (2*R₆) of the multicore optical fiber 100 may be greater than or equal to 175 μm (i.e., R₆ is greater than or equal to 87.5 μm) and less than or equal to 210.0 μm (i.e., R₆ is less than or equal to 105.0 μm). The above ranges include all subranges within the explicitly disclosed ranges as well as ranges formed from any combination of the endpoints thereof.

The thickness of the primary coating is T_{P}=R₅−R₄. In embodiments, T_{P} is less than or equal to 47.0 μm, less than or equal to 40.0 μm, less than or equal to 35.0 μm, less than or equal to 30.0 μm, less than or equal to 25.0 μm, less than or equal to 20.0 μm, or even less than or equal to 15.0 μm. In embodiments T_{P} is greater than or equal to 7.0 μm and less than or equal to 45.0 μm, greater than or equal to 10.0 μm and less than or equal to 35.0 μm, or even greater than or equal to 10.0 μm and less than or equal to 30.0 μm. The thickness of the secondary coating is T_{S}=R₆−R₅. In embodiments, T_{S} is less than or equal to 45.0 μm, less than or equal to 30.0 μm, less than or equal to 25.0 μm, less than or equal to 20.0 μm, or even less than or equal to 15.0 μm. In embodiments, T_{S} is greater than or equal to 7.0 μm and less than or equal to 45.0 μm, greater than or equal to 10.0 μm and less than or equal to 30.0 μm or even greater than or equal to 10.0 μm and less than or equal to 25.0 μm. The above ranges include all subranges within the explicitly disclosed ranges as well as ranges formed from any combination of the endpoints thereof.

In embodiments, the multicore optical fibers described herein may be used in harnesses in co-packaged optics applications, such as applications in which optical components are coupled to electrical components within the packaging of an electronic device. Accordingly, the length of the multicore optical fiber may be relatively short (i.e., less than 5 meters. In embodiments, the length of the multicore optical fiber 100 (i.e., the length of the multicore optical fiber 100 in the direction of the longitudinal centerline 122 of the common cladding 120) may be greater than or equal to 0.5 meter and less than or equal to 5 meters. For example, the length of the multicore optical fiber 100 may be greater than or equal to 0.5 meter and less than or equal to 4 meters, greater than or equal to 0.5 meters and less than or equal to 3 meters, greater than or equal to 0.5 meters and less than or equal to 2 meters, or even greater than or equal to 0.5 meters and less than or equal to 1 meter. The above ranges include all subranges within the explicitly disclosed ranges as well as ranges formed from any combination of the endpoints thereof.

While FIG. 1 schematically depicts a multicore optical fiber 100 comprising four waveguides 116a, 116b, 116c, and 116d, it should be understood that other embodiments are contemplated and possible, such as embodiments in which the multicore optical fiber comprises two waveguides, three waveguides, or even greater than four waveguides.

Referring now to FIGS. 1-2 and FIGS. 3A-3B, FIG. 2 schematically depicts a cross sectional view of a waveguide 116 of the multicore optical fiber 100 of FIG. 1. In embodiments, each of the waveguides 116 of the multicore optical fiber 100 described herein with respect to FIG. 1 comprises the structure of the waveguide 116 depicted in FIG. 2. The waveguide 116 comprises a core region 132 centered on a core longitudinal centerline 126 and a cladding region 133. The cladding region 133 comprises an inner cladding region 136 encircling and directly contacting the core region 132 and a depressed cladding region 138 encircling and directly contacting the inner cladding region 136. In embodiments, the core region 132 and the cladding region 133 are concentric such that the cross section of the waveguide 116 is generally circular symmetric with respect to the core longitudinal centerline 126. In the embodiment depicted in FIG. 2, the waveguide 116 has an overall waveguide radius r_{c}. The core region 132 has a radius r₁ and the depressed cladding region 138 has a radius r₃ that defines an outer radius of the waveguide 116 such that r₃ corresponds to the radius r_{c} associated with the waveguide 116. The inner cladding region 136 extends between the radius r₁ of the core region 132 and an inner cladding radius r₂ of the inner cladding region 136 such that the inner cladding region 136 has a thickness t₂=r₂−r₁ in the radial direction. The depressed cladding region 138 has a thickness t₃=r₃−r₂ in the radial direction. Accordingly, in the embodiments described herein, the waveguide radius r_{c} corresponds to the radius r₃ of the depressed cladding region 138 and r₃>r₂>r₁. The structure, composition, and optical properties of each of the core region 132, the inner cladding region 136, and the depressed cladding region 138 are described in further detail herein.

The radius r₁ of the core region 132 is selected such that the waveguide is single-moded at the operational wavelength of the waveguide. In embodiments described herein, the radius r₁ of the core region 132 of the waveguide 116 is greater than or equal to 3.5 μm. In embodiments, the radius r₁ of the core region 132 of the waveguide 116 is less than or equal to 5 μm. For example, in embodiments, the radius r₁ of the core region 132 of the waveguide 116 may be greater than or equal to 3.5 μm and less than or equal to 5.0 μm, greater than or equal to 3.5 μm and less than or equal to 4.5 μm, or even greater than or equal to 3.5 μm and less than or equal to 4.0 μm. In embodiments, the radius r₁ of the core region 132 of the waveguide 116 may be greater than or equal to 4.0 μm and less than or equal to 5.0 μm or even greater than or equal to 4.5 μm and less than or equal to 5.0 μm. The above ranges include all subranges within the explicitly disclosed ranges as well as ranges formed from any combination of the endpoints thereof.

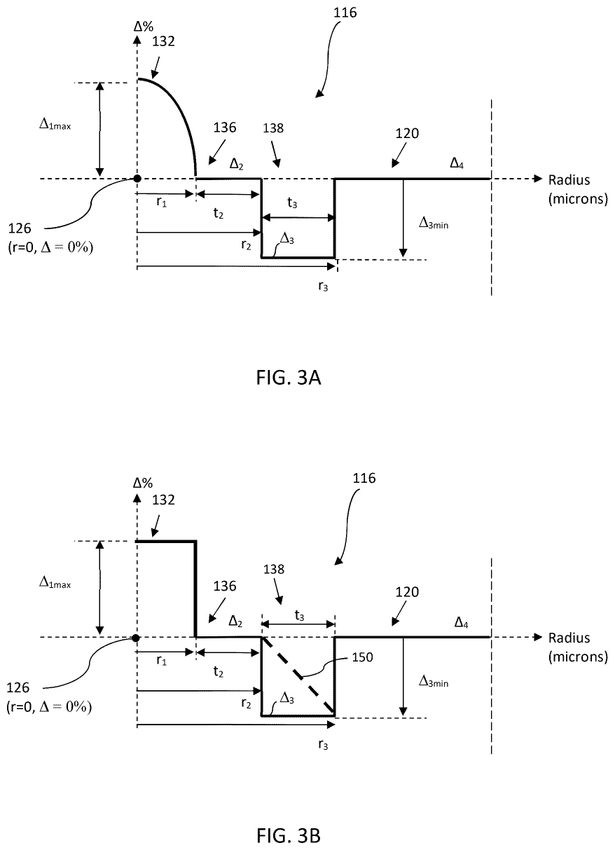

In the embodiments described herein, the core region 132 of the waveguide 116 has a core relative refractive index Δ₁ relative to the refractive index of the common cladding 120 and a maximum core relative refractive index Δ₁ₘₐₓ relative to the refractive index of the common cladding 120. When the common cladding 120 of the multicore optical fiber 100 is formed from pure silica glass, the maximum core relative refractive index Δ₁ₘₐₓ is relative to pure silica glass. The maximum core relative refractive index Δ₁ₘₐₓ refers to the maximum value of the core relative refractive index Δ₁ in the core region 132 of the waveguide 116. In embodiments, Δ₁ may be equal to Δ₁ₘₐₓ throughout the core region 132, such as in embodiments where the core region 132 has a step-index profile as depicted in FIG. 3B. In other embodiments, Δ₁ may be equal to Δ₁ₘₐₓ at or proximate to the core longitudinal centerline 126, such as in embodiments where the core region 132 has a graded-index profile as depicted in FIG. 3A. In the embodiments described herein, Δ₁ₘₐₓ>Δ₁>Δ₄.

In embodiments, the core relative refractive index Δ₁ₘₐₓ may be greater than or equal to 0.30% and less than or equal to 0.40% to achieve the desired optical properties in the core region 132 of the waveguide 116, including the desired mode field diameter, dispersion, bend loss, and cable cutoff wavelength. For example, the core relative refractive index Δ₁ₘₐₓ may be greater than or equal to 0.31% and less than or equal to 0.40%, greater than or equal to 0.32% and less than or equal to 0.40%, greater than or equal to 0.33% and less than or equal to 0.40%, greater than or equal to 0.34% and less than or equal to 0.40%, greater than or equal to 0.35% and less than or equal to 0.40%, greater than or equal to 0.36% and less than or equal to 0.40%, greater than or equal to 0.37% and less than or equal to 0.40%, or even greater than or equal to 0.38% and less than or equal to 0.40%. In embodiments, the core relative refractive index Δ₁ₘₐₓ may be greater than or equal to 0.30% and less than or equal to 0.39%, greater than or equal to 0.30% and less than or equal to 0.38%, greater than or equal to 0.30% and less than or equal to 0.37%, greater than or equal to 0.30% and less than or equal to 0.36%, greater than or equal to 0.30% and less than or equal to 0.35%, greater than or equal to 0.30% and less than or equal to 0.34%, greater than or equal to 0.30% and less than or equal to 0.33%, or even greater than or equal to 0.30% and less than or equal to 0.32%. The above ranges include all subranges within the explicitly disclosed ranges as well as ranges formed from any combination of the endpoints thereof.

In the embodiments described herein, the core relative refractive index Δ₁ₘₐₓ may be achieved in the core region 132 by up-doping the core region 132 with one or more up-dopants that increase the refractive index of the glass of the core region 132 relative to the glass of the common cladding 120. For example, the glass of the core region 132 may be formed from silica-based glass up-doped with one or more of GeO₂, Al₂O₃, P₂O₅, TiO₂, ZrO₂, Nb₂O₅, Cl, and/or Ta₂O₅. In embodiments, the core region 132 may be silica-based glass up-doped with GeO₂. To achieve the aforementioned values for the core relative refractive index Δ₁ₘₐₓ, the glass of the core region 132 may contain a maximum concentration of GeO₂ that is greater than or equal to 5.5 wt % and less than or equal to 7.3 wt %. For example, in embodiments, the maximum concentration of GeO₂ in the core region 132 may be greater than or equal to 5.5 wt % and less than or equal to 7.2 wt %, greater than or equal to 5.5 wt % and less than or equal to 7.1 wt %, greater than or equal to 5.5 wt % and less than or equal to 7.0 wt %, greater than or equal to 5.5 wt % and less than or equal to 6.9 wt %, greater than or equal to 5.5 wt % and less than or equal to 6.8 wt %, greater than or equal to 5.5 wt % and less than or equal to 6.7 wt %, greater than or equal to 5.5 wt % and less than or equal to 6.6 wt %, greater than or equal to 5.5 wt % and less than or equal to 6.5 wt %, greater than or equal to 5.5 wt % and less than or equal to 6.4 wt %, greater than or equal to 5.5 wt % and less than or equal to 6.3 wt %, greater than or equal to 5.5 wt % and less than or equal to 6.2 wt %, greater than or equal to 5.5 wt % and less than or equal to 6.1 wt %, greater than or equal to 5.5 wt % and less than or equal to 6.0 wt %, greater than or equal to 5.5 wt % and less than or equal to 5.9 wt %, greater than or equal to 5.5 wt % and less than or equal to 5.8 wt %, or even greater than or equal to 5.5 wt % and less than or equal to 5.7 wt %. In embodiments, the maximum concentration of GeO₂ in the core region 132 may be greater than or equal to 5.7 wt % and less than or equal to 7.3 wt %, greater than or equal to 5.9 wt % and less than or equal to 7.3 wt %, greater than or equal to 6.0 wt % and less than or equal to 7.3 wt %, greater than or equal to 6.1 wt % and less than or equal to 7.3 wt %, greater than or equal to 6.2 wt % and less than or equal to 7.3 wt %, greater than or equal to 6.3 wt % and less than or equal to 7.3 wt %, greater than or equal to 6.4 wt % and less than or equal to 7.3 wt %, greater than or equal to 6.5 wt % and less than or equal to 7.3 wt %, greater than or equal to 6.6 wt % and less than or equal to 7.3 wt %, greater than or equal to 6.7 wt % and less than or equal to 7.3 wt %, greater than or equal to 6.8 wt % and less than or equal to 7.3 wt %, greater than or equal to 6.9 wt % and less than or equal to 7.3 wt %, greater than or equal to 7.0 wt % and less than or equal to 7.3 wt %, or even greater than or equal to 7.1 wt % and less than or equal to 7.3 wt %. The above ranges include all subranges within the explicitly disclosed ranges as well as ranges formed from any combination of the endpoints thereof.

In the embodiments described herein, the core region 132 of the waveguide 116 is free of optically active materials that create a gain action of optical signals propagating in the core region 132 of the waveguide 116. In particular, in the embodiments described herein, the core region 132 of the waveguide 116 is free of rare-earth dopants (such as Yb, Er, Nd Tm, Sm and Tb), oxides thereof, and compounds thereof.

In embodiments, the core region 132 may have an alpha profile with a core alpha value of greater than or equal to 2 and less than or equal to 20. In embodiments, the core region 132 may have an alpha value greater than or equal to 3 and less than 15, greater than or equal to 4 and less than 13, greater than or equal to 5 and less than 12, or even greater than or equal to 6 and less than or equal to 11. In embodiments, the core region 132 may have a step-index profile with a core alpha value greater than or equal to 10 and less than or equal to 20, as depicted in FIG. 3B. In embodiments where the core region 132 includes a step-index profile, the desired mode field diameter may be achieved in core regions 132 with smaller radii. In embodiments, the core region 132 may have a graded-index profile with a core alpha value greater than or equal to 2 and less than 10, as depicted in FIG. 3A.

In embodiments described herein, the radial thickness t₂ of the inner cladding region 136 of the waveguide 116 is greater than or equal to 2.0 μm. Forming the inner cladding region 136 such that it has a radial thickness t2 of greater than or equal to 2.0 μm (such as 2.0 μm to 6.5 μm) aids in centering the zero dispersion wavelength at a desired value based on the operating wavelengths of the multicore optical fibers. In embodiments, the radial thickness t₂ of the inner cladding region 136 of the waveguide 116 is less than or equal to 6.5 μm. For example, in embodiments, the radial thickness t₂ of the inner cladding region 136 of the waveguide 116 may be greater than or equal to 2.0 μm and less than or equal to 6.5 μm, greater than or equal to 2.5 μm and less than or equal to 6.5 μm, greater than or equal to 3.0 μm and less than or equal to 6.5 μm, greater than or equal to 3.5 μm and less than or equal to 6.5 μm, greater than or equal to 4.0 μm and less than or equal to 6.5 μm, greater than or equal to 4.5 μm and less than or equal to 6.5 μm, greater than or equal to 5.0 μm and less than or equal to 6.5 μm, greater than or equal to 5.5 μm and less than or equal to 6.5 μm, or even greater than or equal to 6.0 μm and less than or equal to 6.5 μm. In embodiments, the radial thickness t₂ of the inner cladding region 136 of the waveguide 116 may be greater than or equal to 2.0 μm and less than or equal to 6.5 μm, greater than or equal to 2.0 μm and less than or equal to 6.0 μm, greater than or equal to 2.0 μm and less than or equal to 5.5 μm, greater than or equal to 2.0 μm and less than or equal to 5.0 μm, greater than or equal to 2.0 m and less than or equal to 4.5 μm, greater than or equal to 2.0 μm and less than or equal to 4.0 am, greater than or equal to 2.0 μm and less than or equal to 3.5 am, greater than or equal to 2.0 μm and less than or equal to 3.0 μm, or even greater than or equal to 2.0 μm and less than or equal to 2.5 μm. The above ranges include all subranges within the explicitly disclosed ranges as well as ranges formed from any combination of the endpoints thereof.

In the embodiments described herein, the inner cladding region 136 of the waveguide 116 has an inner cladding relative refractive index Δ₂ relative to the refractive index of the common cladding 120. In embodiments, the inner cladding relative refractive index Δ₂ is relative to pure silica glass, such as when the common cladding 120 is formed from pure silica glass. In embodiments, the inner cladding relative refractive index Δ₂ is less than or equal to the core relative refractive index Δ₁ and less than the maximum core relative refractive index Δ₁ₘₐₓ (i.e., Δ₂≤Δ₁, Δ₂<Δ₁ₘₐₓ). In embodiments, Δ₂ may be greater than or equal to Δ₄ or Δ₂ may be less than or equal to Δ₄. For example, in embodiments, the difference between Δ₂ and Δ₄ may be greater than or equal to −0.05% and less than or equal to 0.05%.

In embodiments, the inner cladding relative refractive index Δ₂ may be greater than or equal to −0.05% and less than or equal to 0.05%, greater than or equal to −0.04% and less than or equal to 0.05%, greater than or equal to −0.03% and less than or equal to 0.05%, greater than or equal to −0.02% and less than or equal to 0.05%, greater than or equal to −0.01% and less than or equal to 0.05%, greater than or equal to 0.00% and less than or equal to 0.05%, greater than or equal to 0.01% and less than or equal to 0.05%, greater than or equal to 0.002% and less than or equal to 0.05%, or even greater than or equal to 0.03% and less than or equal to 0.05%. In embodiments, the inner cladding relative refractive index Δ₂ may be greater than or equal to −0.05% and less than or equal to 0.04%, greater than or equal to −0.05% and less than or equal to 0.03%, greater than or equal to −0.05% and less than or equal to 0.02%, greater than or equal to −0.05% and less than or equal to 0.01%, greater than or equal to −0.05% and less than or equal to 0.00%, greater than or equal to −0.05% and less than or equal to −0.01%, greater than or equal to −0.05% and less than or equal to −0.02%, greater than or equal to −0.05% and less than or equal to −0.03%, or even greater than or equal to −0.05% and less than or equal to −0.04%. The above ranges include all subranges within the explicitly disclosed ranges as well as ranges formed from any combination of the endpoints thereof.

In the embodiments described herein, the inner cladding relative refractive index Δ₂ may be achieved in the inner cladding region 136 of the waveguide 116 by up-doping the inner cladding region 136 with one or more up-dopants that increase the refractive index of the glass of the inner cladding region 136 relative to pure silica glass or by down-doping the inner cladding region 136 with one or more down-dopants that decrease the refractive index of the glass of the inner cladding region 136 relative to pure silica glass. When the inner cladding region is up-doped, the inner cladding relative refractive index Δ₂ of each waveguide of the at least two waveguides is greater than 0% and less than or equal to 0.05%. When the inner cladding region is down-doped, the inner cladding relative refractive index Δ₂ of each waveguide of the at least two waveguides is less than 0% and greater than or equal to −0.05%.

For example, the glass of the inner cladding region 136 may be formed from silica-based glass up-doped with one or more of GeO₂ or chlorine (Cl). In embodiments the inner cladding region 136 of each waveguide of the at least two waveguides is up-doped with GeO₂ and the concentration of GeO₂ in the inner cladding region 136 is greater than 0 wt % and less than or equal to 1.0 wt %. For example, in embodiments, the amount of GeO₂ in the inner cladding region 136 is greater than 0 wt % and less than or equal to 0.75 wt %, greater than 0 wt % and less than or equal to 0.50 wt %, or even greater than 0 wt % and less than or equal to 0.25 wt. The above ranges include all subranges within the explicitly disclosed ranges as well as ranges formed from any combination of the endpoints thereof.

In embodiments the inner cladding region 136 of each waveguide of the at least two waveguides is up-doped with chlorine (Cl) and the concentration of Cl in the inner cladding region 136 is greater than 0 wt % and less than or equal to 1.5 wt %. For example, in embodiments, the amount of Cl in the inner cladding region 136 is greater than 0 wt % and less than or equal to 1.25 wt %, greater than 0 wt % and less than or equal to 1.00 wt %, greater than 0 wt % and less than or equal to 0.75 wt %, greater than 0 wt % and less than or equal to 0.50 wt %, or even greater than 0 wt % and less than or equal to 0.25 wt %. The above ranges include all subranges within the explicitly disclosed ranges as well as ranges formed from any combination of the endpoints thereof.

In other embodiments, the glass of the inner cladding region 136 may be formed from silica-based glass down-doped with fluorine (F). In such embodiments, the concentration of F in the inner cladding region 136 is greater than 0 wt % and less than or equal to 1.5 wt %. For example, in embodiments, the amount of F in the inner cladding region 136 is greater than 0 wt % and less than or equal to 1.25 wt %, greater than 0 wt % and less than or equal to 1.00 wt %, greater than 0 wt % and less than or equal to 0.75 wt %, greater than 0 wt % and less than or equal to 0.50 wt %, or even greater than 0 wt % and less than or equal to 0.25 wt %. The above ranges include all subranges within the explicitly disclosed ranges as well as ranges formed from any combination of the endpoints thereof.

In embodiments, the refractive index of the inner cladding region 136 is the same as the refractive index of the common cladding 120 of the multicore optical fiber 100 such that the inner cladding relative refractive index Δ₂ is 0%. In embodiments, both the inner cladding region 136 and the common cladding 120 of the multicore optical fiber 100 may be formed from un-doped silica glass (i.e., silica-based glass without any intentionally added dopants). Alternatively, both the inner cladding region 136 and the common cladding 120 of the multicore optical fiber 100 may be formed from silica glass up-doped (or down-doped) with the same dopants such that the inner cladding relative refractive index Δ₂ is 0%.

In embodiments described herein, the radial thickness t₃ of the depressed cladding region 138 of the waveguide 116 is greater than 0 μm. In embodiments, the radial thickness t₃ of the depressed cladding region 138 of the waveguide 116 is less than or equal to 6.5 μm. For example, in embodiments, the radial thickness t₃ of the depressed cladding region 138 of the waveguide 116 may be greater than 0 μm and less than or equal to 5.5 μm, greater than 0 μm and less than or equal to 5.00 μm, greater than 0 μm and less than or equal to 4.75 μm, greater than 0 μm and less than or equal to 4.50 μm, greater than 0 μm and less than or equal to 4.25 μm, greater than 0 μm and less than or equal to 4.00 μm, greater than 0 μm and less than or equal to 3.75 μm, greater than 0 μm and less than or equal to 3.5 μm, greater than 0 μm and less than or equal to 3.25 μm, greater than 0 μm and less than or equal to 3.00 μm, greater than 0 μm and less than or equal to 2.75 μm, greater than 0 μm and less than or equal to 2.5 μm, greater than 0 μm and less than or equal to 2.25 μm, greater than 0 μm and less than or equal to 2.00 μm, greater than 0 μm and less than or equal to 1.75 μm, greater than 0 μm and less than or equal to 1.50 μm, greater than 0 μm and less than or equal to 1.25 μm, greater than 0 μm and less than or equal to 1.00 μm, or even greater than 0 μm and less than or equal to 0.50 μm. In embodiments, the radial thickness t₃ of the depressed cladding region 138 of the waveguide 116 may be greater than or equal to 0.25 μm and less than or equal to 6.50 μm, greater than or equal to 0.50 μm and less than or equal to 6.50 μm, greater than or equal to 0.75 μm and less than or equal to 6.50 μm, greater than or equal to 1.00 μm and less than or equal to 6.50 μm, greater than or equal to 1.25 μm and less than or equal to 6.50 μm, greater than or equal to 1.50 μm and less than or equal to 6.50 μm, greater than or equal to 1.75 μm and less than or equal to 6.50 μm, greater than or equal to 2.00 μm and less than or equal to 6.50 μm, greater than or equal to 2.25 μm and less than or equal to 6.50 μm, greater than or equal to 2.50 μm and less than or equal to 6.50 μm, greater than or equal to 2.75 μm and less than or equal to 6.50 μm, greater than or equal to 3.00 μm and less than or equal to 6.50 μm, greater than or equal to 3.25 μm and less than or equal to 6.50 μm, greater than or equal to 3.50 μm and less than or equal to 6.50 μm, greater than or equal to 3.75 μm and less than or equal to 6.50 μm, greater than or equal to 4.00 μm and less than or equal to 6.50 μm, greater than or equal to 4.25 μm and less than or equal to 6.50 μm, greater than or equal to 4.50 μm and less than or equal to 6.50 μm, greater than or equal to 4.75 μm and less than or equal to 6.50 μm, greater than or equal to 5.00 μm and less than or equal to 6.50 μm, greater than or equal to 5.25 μm and less than or equal to 6.50 μm, greater than or equal to 5.50 μm and less than or equal to 6.50 μm, greater than or equal to 5.75 μm and less than or equal to 6.50 μm, greater than or equal to 6.00 μm and less than or equal to 6.50 μm, or even greater than or equal to 6.25 μm and less than or equal to 6.50 μm. The above ranges include all subranges within the explicitly disclosed ranges as well as ranges formed from any combination of the endpoints thereof.

The depressed cladding region 138 has a depressed relative refractive index Δ₃ relative to the refractive index of the common cladding 120. In embodiments, the depressed relative refractive index Δ₃ is relative to pure silica glass, such as when the common cladding 120 is formed from pure silica glass. In embodiments, the depressed relative refractive index Δ₃ is less than the inner cladding relative refractive index Δ₂ of the inner cladding region 136 throughout the depressed cladding region 138. The depressed relative refractive index Δ₃ may also be less than the common cladding relative refractive index Δ₄ of the common cladding 120 of the multicore optical fiber 100 (see FIG. 1) such that the depressed cladding region 138 forms a trench in the relative refractive index profile of the waveguide 116. The term “trench,” as used herein, refers to a region of the waveguide that is, in radial cross section, surrounded by regions of the optical fiber (e.g., the inner cladding region 136 and the common cladding 120) having relatively higher refractive indexes.

In embodiments, the depressed relative refractive index Δ₃ may be constant throughout the depressed cladding region 138, as depicted in FIGS. 3A and 3B wherein the depressed cladding region 138 has a rectangular relative refractive index profile. Alternatively, the depressed relative refractive index Δ₃ may vary with the radial coordinate r (radius) and be represented as Δ₃(r) as depicted by the dashed line 150 in FIG. 3B which indicates the depressed relative refractive index Δ₃ as a function of the radius r (i.e., Δ₃(r)). In embodiments, the depressed relative refractive index Δ₃(r) within the depressed cladding region 138 comprises a minimum depressed relative refractive index Δ₃ₘᵢₙ. In embodiments Δ₁ₘₐₓ≥Δ₁≥Δ₂>Δ₃. In embodiments Δ₁ₘₐₓ≥Δ₁≥Δ₂>Δ₃ₘᵢₙ. In embodiments, Δ₂>Δ₃ₘᵢₙ such that the depressed cladding region 138 forms a depressed-index trench in a relative refractive index profile of each waveguide between r₂ and r₃. In embodiments, Δ₃<Δ₄. In embodiments, Δ₃ₘᵢₙ<Δ₄. In embodiments, the depressed relative refractive index Δ₃(r) of the depressed cladding region 138 of each waveguide 116 decreases with increasing radial distance from a longitudinal centerline of each waveguide to the minimum depressed relative refractive index Δ₃ₘᵢₙ, as indicated by the dashed line 150 in FIG. 3B. In such an embodiment, the depressed cladding region 138 may have a triangular relative refractive index profile. Accordingly, based on FIGS. 3A and 3B, it should be understood that the depressed relative refractive index Δ₃ may be constant throughout the depressed cladding region 138 or may decrease with increasing radial distance from a longitudinal centerline of each waveguide to the minimum depressed relative refractive index Δ₃ₘᵢₙ. It should also be understood that the waveguide 116 may be formed with a core region 132 comprising a graded-index profile (FIG. 3A) and a depressed cladding region 138 comprising a rectangular relative refractive index profile or a triangular relative refractive index profile. It should also be understood that the waveguide 116 may be formed with a core region 132 comprising a step-index profile (FIG. 3B) and a depressed cladding region 138 comprising a rectangular relative refractive index profile or a triangular relative refractive index profile.

In embodiments, the depressed cladding region 138 comprises silica glass having one or more down-dopants, such as fluorine. In embodiments, the down-dopant concentration within the depressed cladding region 138 is uniform as a function of radial distance from the core longitudinal centerline 126 of the waveguide 116 such that the relative refractive index profile of the depressed cladding region 138 has rectangular shape, as depicted in the relative refractive index profile of FIG. 3A.

In other embodiments, the down-dopant concentration within the depressed cladding region 138 varies as a function of radial distance from the core longitudinal centerline 126 of the waveguide 116 such that the relative refractive index profile of the depressed cladding region 138 has a triangular or continuously sloping shape, as described herein and depicted by the dashed line 150 in FIG. 3B. For example, in embodiments, the down dopant concentration increases in the depressed cladding region 138 as a function of increasing radial distance from the core longitudinal centerline 126 of the waveguide 116, reaching a maximum at or near the radius r₃. In such embodiments, the depressed relative refractive index Δ₃(r) within the depressed cladding region 138 decreases with increasing radial distance from the core longitudinal centerline 126 of the waveguide 116 to a depressed minimum relative refractive index Δ₃ₘᵢₙ at r=r₃.

In embodiments, the maximum concentration of fluorine in the depressed cladding region 138 is greater than or equal to 0.65 wt % and less than or equal to 3.0 wt %. For example, the maximum fluorine concentration in the depressed cladding region may be greater than or equal to 0.75 wt % and less than or equal to 3.0 wt %, greater than or equal to 1.0 wt % and less than or equal to 3.0 wt %, greater than or equal to 1.25 wt % and less than or equal to 3.0 wt %, greater than or equal to 1.50 wt % and less than or equal to 3.0 wt %, greater than or equal to 1.75 wt % and less than or equal to 3.0 wt %, greater than or equal to 2.0 wt % and less than or equal to 3.0 wt %, greater than or equal to 2.25 wt % and less than or equal to 3.0 wt %, greater than or equal to 2.50 wt % and less than or equal to 3.0 wt %, or even greater than or equal to 2.75 wt % and less than or equal to 3.0 wt %. In embodiments, the maximum fluorine concentration in the depressed cladding region may be greater than or equal to 0.65 wt % and less than or equal to 2.75 wt %, greater than or equal to 0.65 wt % and less than or equal to 2.50 wt %, greater than or equal to 0.65 wt % and less than or equal to 2.25 wt %, greater than or equal to 0.65 wt % and less than or equal to 2.0 wt %, greater than or equal to 0.65 wt % and less than or equal to 1.75 wt %, greater than or equal to 0.65 wt % and less than or equal to 1.50 wt %, greater than or equal to 0.65 wt % and less than or equal to 1.25 wt %, greater than or equal to 0.65 wt % and less than or equal to 1.0 wt %, or even greater than or equal to 0.65 wt % and less than or equal to 0.75 wt %. The above ranges include all subranges within the explicitly disclosed ranges as well as ranges formed from any combination of the endpoints thereof.

In embodiments, Δ₃ₘᵢₙ of the depressed cladding region 138 is less than or equal −0.20% and greater than or equal to −1.0%, less than or equal −0.30% and greater than or equal to −0.75%, or even less than or equal −0.40% and greater than or equal to −0.50%. In embodiments, Δ₃ₘᵢₙ of the depressed cladding region 138 is less than or equal −0.50% and greater than or equal to −1.0% or even less than or equal −0.75% and greater than or equal to −1.0%. The above ranges include all subranges within the explicitly disclosed ranges as well as ranges formed from any combination of the endpoints thereof.

The radial thickness t₃ of the depressed cladding region 138 may be interrelated with the minimum relative refractive index Δ₃ₘᵢₙ of the depressed cladding region 138.

Specifically, the depressed cladding region 138 may have a trench volume V_{T} defined as:

$${v}_{T} = \vert 2 {\int }_{0}^{∞} {Δ}_{3} ( r ) rdr \vert \qquad ( 7 )$$

where r₂ corresponds to the inner radius of the depressed cladding region 138 of the refractive index profile, r₃ is the outer radius of the depressed cladding region 138 of the refractive index profile, Δ₃(r) is the relative refractive index of the depressed cladding region 138 of the refractive index profile, and r is radial position in the fiber. Trench volume will be expressed herein in units of % Δmicron², % Δ-micron², % Δ-m², % Δμm², or %-micron², whereby these units can be used interchangeably herein.

Without wishing to be bound by theory, it is believed that the trench volume V_{T} within the depressed cladding region 138 influences the mode field diameter of the waveguide 116. In particular, it is believed that larger trench volumes V_{T} tend to confine the light travelling through the waveguide 116 and make the mode field diameter of each waveguide 116 smaller.

In embodiments described herein, the trench volume V_{T} may be greater than or equal to 20%-μm² and less than or equal to 45%-μm². In embodiments, the trench volume V_{T} may be greater than or equal to 25%-μm² and less than or equal to 40%-μm², greater than or equal to 30%-μm² and less than or equal to 40%-μm², or even greater than or equal to 30%-μm² and less than or equal to 35%-μm². In embodiments, the trench volume V_{T} may be greater than or equal to 30%-μm² and less than or equal to 45%-μm², greater than or equal to 35%-μm² and less than or equal to 45%-μm², or even greater than or equal to 40%-μm² and less than or equal to 45%-μm². The above ranges include all subranges within the explicitly disclosed ranges as well as ranges formed from any combination of the endpoints thereof.

The mode field diameter relates to the amount of optical power (i.e., the power of the light) that can be coupled into the waveguide 116. In embodiments, the mode field diameter of each waveguide 116 at 1310 nm is greater than or equal to 8.2 μm and less than or equal to 9.0 μm. For example, in embodiments, the mode field diameter of the waveguide 116 at 1310 nm may be greater than or equal to 8.2 μm and less than or equal to 8.8 μm, greater than or equal to 8.2 μm and less than or equal to 8.6 μm, or even greater than or equal to 8.2 μm and less than or equal to 8.5 μm to facilitate coupling with standard single mode fibers. In embodiments, the mode field diameter of the waveguide 116 at 1310 nm may be greater than or equal to 8.4 μm and less than or equal to 9.0 μm, greater than or equal to 8.6 μm and less than or equal to 9.0 μm, or even greater than or equal to 8.8 μm and less than or equal to 9.0 μm to facilitate coupling with standard single mode fibers. The above ranges include all subranges within the explicitly disclosed ranges as well as ranges formed from any combination of the endpoints thereof.

In embodiments, the mode field diameter of each waveguide 116 at 1550 nm is greater than or equal to 9.0 μm and less than or equal to 10.0 μm. For example, in embodiments, the mode field diameter of the waveguide 116 at 1550 nm may be greater than or equal to 9.0 μm and less than or equal to 9.8 μm, greater than or equal to 9.0 μm and less than or equal to 9.6 μm, or even greater than or equal to 9.0 μm and less than or equal to 9.5 μm to facilitate coupling with standard single mode fibers. In embodiments, the mode field diameter of the waveguide 116 at 1550 nm may be greater than or equal to 9.2 μm and less than or equal to 10.0 μm, greater than or equal to 9.4 μm and less than or equal to 10.0 μm, greater than or equal to 9.6 μm and less than or equal to 10.0 μm, or even greater than or equal to 9.8 μm and less than or equal to 10.0 μm to facilitate coupling with standard single mode fibers. The above ranges include all subranges within the explicitly disclosed ranges as well as ranges formed from any combination of the endpoints thereof.

In embodiments, the cable cutoff wavelength of each waveguide 116 of the at least two waveguides is less than or equal to 1150 nm. For example, in embodiments, the cable cutoff wavelength of each waveguide 116 of the plurality of waveguides is less than or equal to 1145 nm, less than or equal to 1140 nm, less than or equal to 1130 nm or even less than or equal to 1120 nm. The above ranges include all subranges within the explicitly disclosed ranges as well as ranges formed from any combination of the endpoints thereof. Without wishing to be bound by theory, it is believed that cable cutoff wavelengths of less than 1150 nm assist with mitigating the transmission of higher order modes in the waveguides 116 of the multicore optical fiber 100 at fiber lengths typically utilized in co-packaged optics applications. In particular, higher order modes present in an optical signal may couple back into the fundamental mode of an optical signal propagating in the waveguides 116 and diminish the quality of the optical signal. However, maintaining the cable cutoff wavelength to values of less than 1150 nm strips out the higher order modes of the optical signals propagating in the waveguides 116, thereby preventing degradation of the quality of the optical signal. Further, it is believed that cable cutoff wavelengths of less than 1150 nm may assist with reducing multi-path interference in the multicore optical fibers described herein. In embodiments, the multicore optical fibers described herein may operate at wavelengths from 1260 nm to 1360 nm (i.e., within the “O-band”) and/or wavelengths from 1530 nm to 1565 nm (i.e., within the “C-band”). The values of the cable cutoff wavelengths described herein facilitate single-mode operation of the multicore optical fibers within these operating wavelengths for fiber application lengths of 0.5 meters to 20 meters (i.e., the length of the multicore optical fiber is 0.5 meters to 20 meters).

In embodiments, the zero dispersion wavelength of each waveguide 116 of the at least two waveguides is greater than or equal to 1300 nm and less than or equal to 1324 nm to mitigate Four Wave Mixing impairments and thereby improve transmission performance. For example, in embodiments, the zero dispersion wavelength of each waveguide 116 is greater than or equal to 1300 nm and less than or equal to 1320, greater than or equal to 1300 nm and less than or equal to 1315, or even greater than or equal to 1300 nm and less than or equal to 1310. In embodiments, the zero dispersion wavelength of each waveguide 116 is greater than or equal to 1305 nm and less than or equal to 1324, greater than or equal to 1310 nm and less than or equal to 1324, or even greater than or equal to 1315 nm and less than or equal to 1324. The above ranges include all subranges within the explicitly disclosed ranges as well as ranges formed from any combination of the endpoints thereof.

The effective area A_{eff} of each waveguide of the multicore optical fibers disclosed herein is greater than 45 μm², greater than 50 μm², greater than 55 μm², greater than 60 μm², or even greater than 65 μm² at a wavelength of 1310 nm to increase the amount of optical power that can be launched into each waveguide of the multicore optical fiber. In embodiments, the effective area A_{eff} of each waveguide of the multicore optical fibers disclosed herein is greater than or equal to 45 μm² to less than or equal to 70 μm², greater than or equal to 50 μm² to less than or equal to 65 μm², greater than or equal to 55 μm² to less than or equal to 65 μm², or even greater than or equal to 55 μm² to less than or equal to 60 μm² at a wavelength of 1310 nm. The above ranges include all subranges within the explicitly disclosed ranges as well as ranges formed from any combination of the endpoints thereof.

The effective area A_{eff} of each waveguide of the multicore optical fibers disclosed herein is greater than 55 μm², greater than 60 μm², greater than 65 μm², greater than 70 μm², greater than 75 μm², or even greater than 80 μm² at a wavelength of 1550 nm to increase the amount of optical power that can be launched into each waveguide of the multicore optical fiber. In embodiments, the effective area A_{eff} of each waveguide of the multicore optical fibers disclosed herein is greater than or equal to 55 μm² to less than or equal to 85 μm², greater than or equal to 60 μm² to less than or equal to 80 μm², greater than or equal to 60 μm² to less than or equal to 75 μm², or even greater than or equal to 65 μm² to less than or equal to 70 μm² at a wavelength of 1550 nm. The above ranges include all subranges within the explicitly disclosed ranges as well as ranges formed from any combination of the endpoints thereof.

In embodiments, the attenuation of the waveguides 116 of the multicore optical fiber 100 is less than or equal to 0.55 dB/km at a wavelength of 1310 nm. In embodiments, the attenuation of the waveguides 116 of the multicore optical fiber 100 is less than or equal to 0.50 dB/km, less than or equal to 0.45 dB/km, less than or equal to 0.40 dB/km, less than or equal to 0.35 dB/km, or even less than or equal to 0.33 dB/km at a wavelength of 1310 nm. The above ranges include all subranges within the explicitly disclosed ranges as well as ranges formed from any combination of the endpoints thereof.

The various embodiments of the multicore optical fibers 100 described herein have improved macrobend losses due to the incorporation of the depressed cladding region 138 within the waveguide 116. In embodiments, the macrobend loss using restricted mode launch (core region only) of the multicore optical fibers described herein is less than or equal to 0.05 dB/turn around a 15 mm diameter mandrel at a wavelength of 1310 nm, less than or equal to 0.04 dB/turn around a 15 mm diameter mandrel at a wavelength of 1310 nm, or even less than or equal to 0.03 dB/turn around a 15 mm diameter mandrel at a wavelength of 1310 nm. In embodiments, the macrobend loss using restricted mode launch (core region only) of the multicore optical fibers described herein is less than or equal to 0.005 dB/turn around a 20 mm diameter mandrel at a wavelength of 1310 nm or even less than or equal to 0.004 dB/turn around a 20 mm diameter mandrel at a wavelength of 1310 nm. In embodiments, the macrobend loss using restricted mode launch (core region only) of the multicore optical fibers described herein is less than or equal to 0.001 dB/turn around a 30 mm diameter mandrel at a wavelength of 1310 nm or even less than or equal to 0.0005 dB/turn around a 30 mm diameter mandrel at a wavelength of 1310 nm. The above ranges include all subranges within the explicitly disclosed ranges as well as ranges formed from any combination of the endpoints thereof.

In embodiments, the macrobend loss using restricted mode launch (core region only) of the multicore optical fibers described herein is less than or equal to 0.7 dB/turn around a 15 mm diameter mandrel at a wavelength of 1550 nm, less than or equal to 0.6 dB/turn around a 15 mm diameter mandrel at a wavelength of 1550 nm, less than or equal to 0.5 dB/turn around a 15 mm diameter mandrel at a wavelength of 1550 nm, less than or equal to 0.4 dB/turn around a 15 mm diameter mandrel at a wavelength of 1550 nm, or even less than or equal to 0.35 dB/turn around a 15 mm diameter mandrel at a wavelength of 1550 nm. In embodiments, the macrobend loss using restricted mode launch (core region only) of the multicore optical fibers described herein is less than or equal to 0.7 dB/turn around a 20 mm diameter mandrel at a wavelength of 1550 nm, less than or equal to 0.6 dB/turn around a 20 mm diameter mandrel at a wavelength of 1550 nm, less than or equal to 0.5 dB/turn around a 20 mm diameter mandrel at a wavelength of 1550 nm, less than or equal to 0.4 dB/turn around a 20 mm diameter mandrel at a wavelength of 1550 nm, or even less than or equal to 0.35 dB/turn around a 20 mm diameter mandrel at a wavelength of 1550 nm. In embodiments, the macrobend loss using restricted mode launch (core region only) of the multicore optical fibers described herein is less than or equal to 0.05 dB/turn around a 30 mm diameter mandrel at a wavelength of 1550 nm, less than or equal to 0.04 dB/turn around a 30 mm diameter mandrel at a wavelength of 1550 nm, less than or equal to 0.03 dB/turn around a 30 mm diameter mandrel at a wavelength of 1550 nm, less than or equal to 0.025 dB/turn around a 30 mm diameter mandrel at a wavelength of 1550 nm, or even less than or equal to 0.020 dB/turn around a 30 mm diameter mandrel at a wavelength of 1550 nm. The above ranges include all subranges within the explicitly disclosed ranges as well as ranges formed from any combination of the endpoints thereof.

In the embodiments described herein, the co-propagating inter-waveguide cross talk at a wavelength of 1310 nm between each core region and a nearest neighbor core region is less than or equal to a −35 dB, less than or equal to −40 dB, less than or equal to −45 dB, or even less than or equal to −50 dB for application lengths of 20 m. In embodiments, the co-propagating inter-waveguide cross talk at a wavelength of 1550 nm between each core region and a nearest neighbor core region is less than or equal to a −20 dB, less than or equal to −25 dB, less than or equal to −30 dB, or even less than or equal to −35 dB for application lengths of 20 m. The above ranges include all subranges within the explicitly disclosed ranges as well as ranges formed from any combination of the endpoints thereof.

In the embodiments described herein, the co-propagating inter-waveguide cross talk at a wavelength of 1310 nm between each core region and a nearest neighbor core region is less than or equal to a −20 dB, less than or equal to −25 dB, less than or equal to −30 dB, or even less than or equal to −35 dB for application lengths of 1000 m. In embodiments, the co-propagating inter-waveguide cross talk at a wavelength of 1550 nm between each core region and a nearest neighbor core region is less than or equal to a −2 dB, less than or equal to −5 dB, less than or equal to −10 dB, or even less than or equal to −15 dB for application lengths of 1000 m. The above ranges include all subranges within the explicitly disclosed ranges as well as ranges formed from any combination of the endpoints thereof.

In the embodiments described herein, the counter-propagating inter-waveguide cross talk at a wavelength of 1310 nm between each core region and a nearest neighbor core region is less than or equal to a −35 dB, less than or equal to −40 dB, less than or equal to −45 dB, or even less than or equal to −50 dB for application lengths of 20 m. In embodiments, the counter-propagating inter-waveguide cross talk at a wavelength of 1550 nm between each core region and a nearest neighbor core region is less than or equal to a −20 dB, less than or equal to −25 dB, less than or equal to −30 dB, or even less than or equal to −35 dB for application lengths of 20 m. The above ranges include all subranges within the explicitly disclosed ranges as well as ranges formed from any combination of the endpoints thereof.

In the embodiments described herein, the counter-propagating inter-waveguide cross talk at a wavelength of 1310 nm between each core region and a nearest neighbor core region is less than or equal to a −40 dB, less than or equal to −45 dB, less than or equal to −50 dB, or even less than or equal to −55 dB for application lengths of 1000 m. In embodiments, the counter-propagating inter-waveguide cross talk at a wavelength of 1550 nm between each core region and a nearest neighbor core region is less than or equal to a −10 dB, less than or equal to −15 dB, less than or equal to −20 dB, or even less than or equal to −25 dB for application lengths of 1000 m. The above ranges include all subranges within the explicitly disclosed ranges as well as ranges formed from any combination of the endpoints thereof.

As noted herein, in conventional computing centers, data signals may be transmitted to and between the electronic devices of the computing center optically, through optical fibers. The optical signals transmitted through the optical fibers are converted to electrical signals through a transceiver and the electrical signals are transmitted from the transceiver to the electronic devices of the computing center. The multicore optical fibers 100 described herein may be used, for example in electronic devices, such as opto-electronic devices, to increase the data transmission density or shore density of data delivered to the electronic components of the electronic device. Such devices may be used, for example, in data centers and other, similar computing applications.

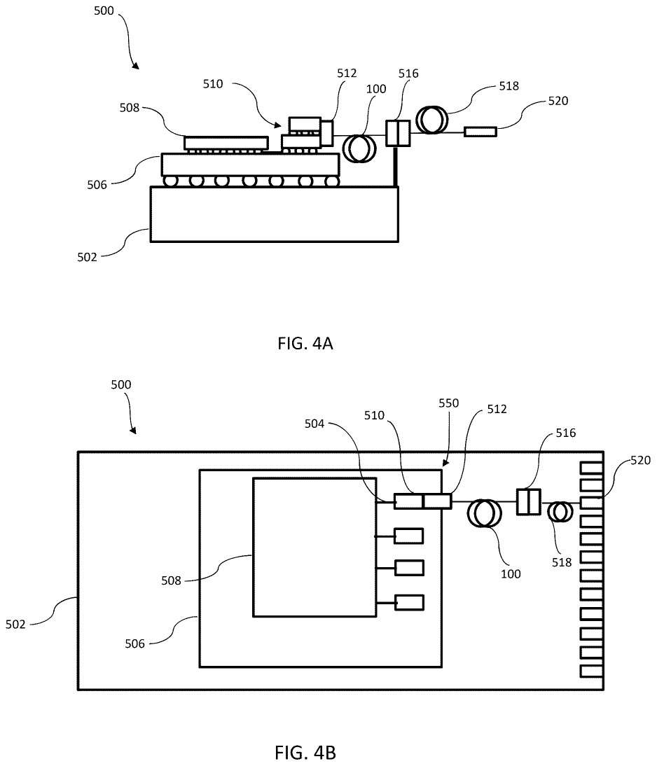

Referring now to FIGS. 4A and 4B, a cross section (FIG. 4A) and a top view (FIG. 4B) of an electronic device 500 utilizing the multicore optical fibers described herein is schematically depicted. The electronic device 500 may be utilized, for example, in switches utilized in computing centers. The electronic device 500 generally includes a printed circuit board 502 and a processor circuit board 506 in electrical communication with the printed circuit board 502. The processor circuit board 508 includes an application specific integrated circuit (ASIC) 508 (such as a switch ASIC) communicatively coupled with a plurality of co-packaged optical transceiver chips 510 through electrical traces 504 formed in the processor circuit board 506. The co-packaged optical transceiver chips 510 facilitate converting optical signals into electrical signals and converting electrical signals to optical signals. Each co-packaged optical transceiver chip 510 may include multiple (at least two) input/output (I/O) channels for receiving and emitting optical signals. Each of the co-packaged optical transceiver chips 510 is optically coupled to a co-packaged optics (CPO) connector 512 (one depicted in FIGS. 4A and 4B for ease of description) that facilitates coupling optical signals into and out of the corresponding co-packaged optical transceiver chip 510. Each CPO connector 512 is, in turn, optically coupled to a first end of a multicore optical fiber 100, such as the multicore optical fibers 100 described herein. In particular, the CPO connector 512 may contain a number of channels corresponding to the number of I/O channels of the co-packaged optical transceiver chip 510 to which it is optically coupled. Similarly, the number of channels of the CPO connector 512 corresponds to the number of waveguides of the multicore optical fiber 100. As such, the CPO connector 512 facilitates optically coupling each waveguide of the multicore optical fiber 100 to a corresponding I/O channel of an associated co-packaged optical transceiver chip 510. The second end of the multicore optical fiber 100 is, in turn, optically coupled to a first end of an interconnect optical fiber 518 with a first optical connector 516. A second end of the interconnect optical fiber 518 is, in turn, connected to a second optical connector 520 through which optical signals are received into the electronic device 500 or emitted from the electronic device 500.

In the embodiments of the electronic device 500 described, the combination of the co-packaged optical transceiver chips 510 optically coupled to the multicore optical fibers 100 facilitates increasing the shore density at the interface between the multicore optical fibers 100 and the co-packaged optical transceiver chips 510. In particular, at the die edge 550 of the processor circuit board 506, the shore density may be greater than or equal to 1 terabyte per second per millimeter of length of the die edge 550 (1 Tbps/mm). Such shore densities are facilitated by the co-packaged optical transceiver chips 510 in combination with the configuration and properties of the waveguides of the multicore optical fibers 100 described herein.

### EXAMPLES

The embodiments described herein will be further clarified by the following examples.

Examples of multicore optical fibers were modeled and various properties were determined. In particular, each multicore optical fiber was modeled with either a 1×2 linear array of waveguides or a 1×4 linear array of waveguides disposed in a common cladding, as described herein (i.e., a 1×N linear array of waveguides where N=2 or 4). The common cladding was modeled as having a refractive index of 1.444 (i.e., the common cladding was modeled as being formed from pure silica glass). The waveguides of the multicore optical fibers were modeled as comprising a core region 132, an inner cladding region 136, and a depressed cladding region 138 as depicted in FIG. 2 resulting in a relative refractive index profile as generally depicted in FIG. 3A or FIG. 3B. The core maximum relative refractive index Δ₁ₘₐₓ, core alpha value, core radius r₁, the outer radius r₂ of the inner cladding, the inner cladding relative refractive index Δ₂, the outer radius r₃ of the depressed cladding region, the minimum depressed relative refractive index Δ₃ₘᵢₙ of the depressed cladding region, the trench volume V_{T} of the depressed cladding region, the common cladding relative refractive index Δ₄ of the common cladding, the outer radius R₄ of common cladding, the number of waveguides in the linear array (i.e. “N”), and the waveguide-to-waveguide spacing of the modeled multicore optical fibers are listed in Tables 1A-1C.

TABLE 1A

| | Ex. 1 | Ex. 2 | Ex. 3 | Ex. 4 |
|---|---|---|---|---|
| Δ₁ₘₐₓ (%) | 0.36 | 0.36 | 0.36 | 0.36 |
| Alpha Value | 12 | 12 | 12 | 12 |
| r₁ (μm) | 4 | 4 | 4 | 4 |
| Δ₂ (%) | 0 | 0 | 0 | 0 |
| r₂ (μm) | 8 | 8 | 8 | 8 |
| Δ_{3 min} (%) | −0.4 | −0.4 | −0.47 | −0.47 |
| r₃ (μm) | 12 | 12 | 11.5 | 11.5 |
| V_{T} (% μm²) | −32 | −32 | −32.08 | −32.08 |
| Trench Shape | Rectangular | Rectangular | Rectangular | Rectangular |
| Δ₄ (%) | 0 | 0 | 0 | 0 |
| R₄ (μm) | 62.5 | 40 | 62.5 | 40 |
| No. of | 4 | 2 | 4 | 2 |
| Waveguides | | | | |
| Waveguide-to- | 26 | 26 | 25 | 25 |
| Waveguide | | | | |
| spacing (μm) | | | | |

TABLE 1B

| | Ex. 5 | Ex. 6 | Ex. 7 | Ex. 8 |
|---|---|---|---|---|
| Δ₁ₘₐₓ (%) | 0.36 | 0.36 | 0.36 | 0.36 |
| Alpha Value | 12 | 12 | 12 | 12 |
| r₁ (μm) | 4.2 | 4.2 | 4 | 4 |
| Δ₂ (%) | 0 | 0 | 0 | 0 |
| r₂ (μm) | 8 | 8 | 8 | 8 |
| Δ_{3 min} (%) | −0.29 | −0.29 | −0.5 | −0.5 |
| r₃ (μm) | 12 | 12 | 12 | 12 |
| V_{T} (% μm²) | −23.2 | −23.2 | −40 | −40 |
| Trench Shape | Rectangular | Rectangular | Rectangular | Rectangular |
| Δ₄ (%) | 0 | 0 | 0 | 0 |
| R₄ (μm) | 62.5 | 40 | 62.5 | 40 |
| No. of | 4 | 2 | 4 | 2 |
| Waveguides | | | | |
| Waveguide-to- | 26 | 26 | 26 | 26 |
| Waveguide | | | | |
| spacing (μm) | | | | |

TABLE 1C

| | Ex. 9 | Ex. 10 | Ex. 11 | Ex. 12 |
|---|---|---|---|---|
| Δ₁ₘₐₓ (%) | 0.42 | 0.42 | 0.36 | 0.36 |
| Alpha Value | 2 | 2 | 12 | 12 |
| r₁ (μm) | 5 | 5 | 4 | 4 |
| Δ₂ (%) | 0 | 0 | 0 | 0 |
| r₂ (μm) | 8 | 8 | 7 | 7 |
| Δ_{3 min} (%) | −0.4 | −0.4 | −0.5 | −0.5 |
| r₃ (μm) | 12 | 12 | 12 | 12 |
| V_{T} (% μm²) | −32 | −32 | −26 | −26 |
| Trench Shape | Rectangular | Rectangular | Triangular | Triangular |
| Δ₄ (%) | 0 | 0 | 0 | 0 |
| R₄ (μm) | 62.5 | 40 | 62.5 | 40 |
| No. of | 4 | 2 | 4 | 2 |
| Waveguides | | | | |
| Waveguide-to- | 26 | 26 | 26 | 26 |
| Waveguide | | | | |
| spacing (μm) | | | | |

The tunneling loss of the waveguides adjacent to an outer surface of the common cladding of the multicore optical fiber, the total loss (i.e., the attenuation) of the waveguides of the multicore optical fiber, the mode field diameter (MFD) of each waveguide at wavelengths of 1310 nm and 1550 nm, the effective area (A_{eff}) of each waveguide at wavelengths of 1310 nm and 1550 nm, the cable cutoff wavelength of each waveguide, and the zero dispersion wavelength of each waveguide were determined for each of the modeled multicore optical fibers. The results are reported in Tables 2A-2C.

TABLE 2A

| | Ex. 1 | Ex. 2 | Ex. 3 | Ex. 4 |
|---|---|---|---|---|
| Tunneling loss of | 0.2 | 0.06 | 0.15 | 0.05 |
| outer waveguides | | | | |
| @ 1310 nm (dB/km) | | | | |
| Maximum Total | 0.54 | 0.40 | 0.49 | 0.39 |
| Loss in waveguides | | | | |
| @ 1310 nm (dB/km) | | | | |
| MFD @ 1310 nm (μm) | 8.44 | 8.44 | 8.4 | 8.4 |
| MFD @ 1550 (μm) | 9.43 | 9.43 | 9.35 | 9.35 |
| A_{eff} @ 1310 nm (μm²) | 55.65 | 55.65 | 55.33 | 55.33 |
| A_{eff} @ 1550 nm (μm²) | 68.34 | 68.34 | 67.49 | 67.49 |
| Cable Cutoff | 1116 | 1116 | 1117 | 1117 |
| Wavelength (nm) | | | | |
| Zero Dispersion | 1314 | 1315 | 1310 | 1310 |
| Wavelength (nm) | | | | |

TABLE 2B

| | Ex. 5 | Ex. 6 | Ex. 7 | Ex. 8 |
|---|---|---|---|---|
| Tunneling loss of | 0.21 | 0.08 | 0.12 | 0.04 |
| outer waveguides | | | | |
| @ 1310 nm (dB/km) | | | | |
| Maximum Total | 0.55 | 0.42 | 0.46 | 0.38 |
| Loss in Waveguides | | | | |
| @ 1310 nm (dB/km) | | | | |
| MFD @ 1310 nm (μm) | 8.59 | 8.59 | 8.42 | 8.42 |
| MFD @ 1550 (μm) | 9.58 | 9.58 | 9.37 | 9.37 |
| A_{eff} @ 1310 nm (μm²) | 57.98 | 57.98 | 55.42 | 55.42 |
| A_{eff} @ 1550 nm (μm²) | 70.76 | 70.76 | 67.68 | 67.68 |
| Cable Cutoff | 1150 | 1150 | 1139 | 1139 |
| Wavelength (nm) | | | | |
| Zero Dispersion | 1310 | 1310 | 1311 | 1311 |
| Wavelength (nm) | | | | |

TABLE 2C

| | Ex. 9 | Ex. 10 | Ex. 11 | Ex. 12 |
|---|---|---|---|---|
| Tunneling loss of | 0.2 | 0.06 | 0.21 | 0.08 |
| outer waveguides | | | | |
| @ 1310 nm (dB/km) | | | | |
| Maximum Total | 0.54 | 0.4 | 0.55 | 0.42 |
| Loss in Waveguides | | | | |
| @ 1310 nm (dB/km) | | | | |
| MFD @ 1310 nm (μm) | 8.51 | 8.51 | 8.46 | 8.46 |
| MFD @ 1550 (μm) | 9.55 | 9.55 | 9.54 | 9.54 |
| A_{eff} @ 1310 nm (μm²) | 55.12 | 55.12 | 55.49 | 55.49 |
| A_{eff} @ 1550 nm (μm²) | 69.05 | 69.05 | 69.30 | 69.30 |
| Cable Cutoff | 1116 | 1116 | 1081 | 1081 |
| Wavelength (nm) | | | | |
| Zero Dispersion | 1315 | 1315 | 1314 | 1314 |
| Wavelength (nm) | | | | |

As indicated in Tables 2A-2C, the waveguides adjacent to an outer surface of the common cladding of the multicore optical fiber each had tunneling losses less than 0.55 dB/km at a wavelength of 1310 nm, indicating low tunneling losses for each of the example multicore optical fibers. In addition, the waveguides in each of the example multicore optical fibers had effective areas of greater than 50 μm² at wavelengths of 1310 nm and 1550 nm, indicating the waveguide designs in each of the example multicore optical fibers provided for relatively large effective areas. The waveguides of each of the example multicore optical fibers also exhibited mode field diameters (MFD) of 8.4 μm or greater at wavelengths of 1310 nm and 1550 nm. Further, the cable cutoff wavelengths of the waveguides in each of the example multicore optical fibers were 1150 nm or less, indicating that the waveguide designs are able to strip out the higher order modes of optical signals having operating wavelengths of 1310 nm and 1550 nm propagating in the waveguides, thereby reducing multi-path interference (MPI) and mitigating the loss of signal quality of the optical signals propagating in the waveguides. The waveguides in each of the example multicore optical fibers also exhibited zero dispersion wavelengths of greater than 1300 nm and less than 1324 nm.

The macrobend losses at wavelengths of 1310 nm and 1550 nm were determined for the waveguides of the multicore optical fibers for bend radii of 15 mm, 20 mm, and 30 mm. The results are reported in Tables 3A-3C below.

TABLE 3A

| | Ex. 1 | Ex. 2 | Ex. 3 | Ex. 4 |
|---|---|---|---|---|
| 15 mm Macrobend | 0.024 | 0.024 | 0.029 | 0.029 |
| Loss @ 1310 nm | | | | |
| (dB/turn) | | | | |
| 20 mm Macrobend | 0.0034 | 0.0034 | 0.0037 | 0.0037 |
| Loss @ 1310 nm | | | | |
| (dB/turn) | | | | |
| 30 mm Macrobend | 1.84 × | 1.84 × | 1.15 × | 1.15 × |
| Loss @ 1310 nm | 10⁻⁵ | 10⁻⁵ | 10⁻⁵ | 10⁻⁵ |
| (dB/turn) | | | | |
| 15 mm Macrobend | 0.325 | 0.325 | 0.366 | 0.366 |
| Loss @ 1550 nm | | | | |
| (dB/turn) | | | | |
| 20 mm Macrobend | 0.312 | 0.312 | 0.346 | 0.346 |
| Loss @ 1550 nm | | | | |
| (dB/turn) | | | | |
| 30 mm Macrobend | 0.0184 | 0.0184 | 0.0199 | 0.0199 |
| Loss @ 1550 nm | | | | |
| (dB/turn) | | | | |

TABLE 3B

| | Ex. 5 | Ex. 6 | Ex. 7 | Ex. 8 |
|---|---|---|---|---|
| 15 mm Macrobend | 0.016 | 0.016 | 0.013 | 0.013 |
| Loss @ 1310 nm | | | | |
| (dB/turn) | | | | |
| 20 mm Macrobend | 0.0015 | 0.0015 | 0.0019 | 0.0019 |
| Loss @ 1310 nm | | | | |
| (dB/turn) | | | | |
| 30 mm Macrobend | 1.39 × 10⁻⁷ | 1.39 × 10⁻⁷ | 4.3 × 10⁻⁶ | 4.3 × 10⁻⁶ |
| Loss @ 1310 nm | | | | |
| (dB/turn) | | | | |
| 15 mm Macrobend | 0.612 | 0.612 | 0.185 | 0.185 |
| Loss @ 1550 nm | | | | |
| (dB/turn) | | | | |
| 20 mm Macrobend | 0.179 | 0.179 | 0.179 | 0.179 |
| Loss @ 1550 nm | | | | |
| (dB/turn) | | | | |
| 30 mm Macrobend | 0.0147 | 0.0147 | 0.010 | 0.010 |
| Loss @ 1550 nm | | | | |
| (dB/turn) | | | | |

TABLE 3C

| | Ex. 9 | Ex. 10 | Ex. 11 | Ex. 12 |
|---|---|---|---|---|
| 15 mm Macrobend | 0.028 | 0.028 | 0.041 | 0.041 |
| Loss @ 1310 nm | | | | |
| (dB/turn) | | | | |
| 20 mm Macrobend | 0.004 | 0.004 | 0.006 | 0.006 |
| Loss @ 1310 nm | | | | |
| (dB/turn) | | | | |
| 30 mm Macrobend | 1.2 × 10⁻⁵ | 1.2 × 10⁻⁵ | 1.85 × 10⁻⁵ | 1.85 × 10⁻⁵ |
| Loss @ 1310 nm | | | | |
| (dB/turn) | | | | |
| 15 mm Macrobend | 0.35 | 0.35 | 0.543 | 0.543 |
| Loss @ 1550 nm | | | | |
| (dB/turn) | | | | |
| 20 mm Macrobend | 0.333 | 0.333 | 0.512 | 0.512 |
| Loss @ 1550 nm | | | | |
| (dB/turn) | | | | |
| 30 mm Macrobend | 0.019 | 0.019 | 0.033 | 0.033 |
| Loss @ 1550 nm | | | | |
| (dB/turn) | | | | |

As indicated in Tables 3A-3C, each of the waveguides of the modeled multicore optical fibers had macrobend losses of less than 0.05 dB/turn for bend radii of 15 mm, 20 mm, and 30 mm at a wavelength of 1310 nm, with the bend losses decreasing with increasing bend radius. In addition, each of the waveguides of the modeled multicore optical fibers had macrobend losses of less than 0.7 dB/turn for bend radii of 15 mm, 20 mm, and 30 mm at a wavelength of 1550 nm, with the bend losses decreasing with increasing bend radius. These relatively low macrobend loss values indicate that the multicore optical fibers described herein are well-suited for use in harnesses in co-packaged optics applications used in electronic devices where the relatively small footprint of the packaging of the electronic devices may necessitate directing the multicore optical fibers through tight turns in confined spaces to facilitate the interconnection of electrical and optical components with low signal attenuation as a result of bending the multicore optical fiber through the tight turns.

The co-propagating inter-waveguide cross talk and counter propagating inter-waveguide cross talk of the waveguides of the modeled multicore optical fibers are reported in Tables 4A-C and 5A-5C for wavelengths of 1310 nm and 1550 nm and fiber lengths of 1 meter, 10 meters, 20 meters, 100 meters, and 1000 meters.

TABLE 4A

| | Ex. 1 | Ex. 2 | Ex. 3 | Ex. 4 |
|---|---|---|---|---|
| Co-propagating | −60.2 | −60.2 | −55.95 | −55.95 |
| cross talk at 1310 | | | | |
| nm (1 m length) | | | | |
| (dB) | | | | |
| Co-propagating | −50.2 | −50.2 | −45.95 | −45.95 |
| cross talk at 1310 | | | | |
| nm (10 m length) | | | | |
| (dB) | | | | |
| Co-propagating | −47.2 | −47.2 | −42.94 | −42.94 |
| cross talk at 1310 | | | | |
| nm (20 m length) | | | | |
| (dB) | | | | |
| Co-propagating | −40.2 | −40.2 | −35.95 | −35.95 |
| cross talk at 1310 | | | | |
| nm (100 m length) | | | | |
| (dB) | | | | |
| Co-propagating | −30.2 | −30.2 | −25.95 | −25.95 |
| cross talk at 1310 | | | | |
| nm (1000 m length) | | | | |
| (dB) | | | | |
| Co-propagating | −39.7 | −39.7 | −36.38 | −36.38 |
| cross talk at 1550 | | | | |
| nm (1 m length) | | | | |
| (dB) | | | | |
| Co-propagating | −29.7 | −29.7 | −26.38 | −26.38 |
| cross talk at 1550 | | | | |
| nm (10 m length) | | | | |
| (dB) | | | | |
| Co-propagating | −26.7 | −26.7 | −23.37 | −23.37 |
| cross talk at 1550 | | | | |
| nm (20 m length) | | | | |
| (dB) | | | | |
| Co-propagating | −19.7 | −19.7 | −16.38 | −16.38 |
| cross talk at 1550 | | | | |
| nm (100 m length) | | | | |
| (dB) | | | | |
| Co-propagating | −9.7 | −9.7 | −6.38 | −6.38 |
| cross talk at 1550 | | | | |
| nm (1000 m length) | | | | |
| (dB) | | | | |

TABLE 4B

| | Ex. 5 | Ex. 6 | Ex. 7 | Ex. 8 |
|---|---|---|---|---|
| Co-propagating | −55.48 | −55.48 | −64.52 | −64.52 |
| cross talk at 1310 | | | | |
| nm (1 m length) | | | | |
| (dB) | | | | |
| Co-propagating | −45.48 | −45.48 | −54.52 | −54.52 |
| cross talk at 1310 | | | | |
| nm (10 m length) | | | | |
| (dB) | | | | |
| Co-propagating | −42.47 | −42.47 | −51.52 | −51.52 |
| cross talk at 1310 | | | | |
| nm (20 m length) | | | | |
| (dB) | | | | |
| Co-propagating | −35.48 | −35.48 | −44.52 | −44.52 |
| cross talk at 1310 | | | | |
| nm (100 m length) | | | | |
| (dB) | | | | |
| Co-propagating | −25.48 | −25.48 | −34.52 | −34.52 |
| cross talk at 1310 | | | | |
| nm (1000 m length) | | | | |
| (dB) | | | | |
| Co-propagating | −35.89 | −35.89 | −−43.56 | −43.56 |
| cross talk at 1550 | | | | |
| nm (1 m length) | | | | |
| (dB) | | | | |
| Co-propagating | −25.89 | −25.89 | −33.55 | −33.55 |
| cross talk at 1550 | | | | |
| nm (10 m length) | | | | |
| (dB) | | | | |
| Co-propagating | −22.88 | −22.88 | −30.55 | −30.55 |
| cross talk at 1550 | | | | |
| nm (20 m length) | | | | |
| (dB) | | | | |
| Co-propagating | −15.89 | −15.89 | −23.55 | −23.55 |
| cross talk at 1550 | | | | |
| nm (100 m length) | | | | |
| (dB) | | | | |
| Co-propagating | −5.89 | −5.89 | −13.55 | −13.55 |
| cross talk at 1550 | | | | |
| nm (1000 m length) | | | | |
| (dB) | | | | |

TABLE 4C

| | Ex. 9 | Ex. 10 | Ex. 11 | Ex. 12 |
|---|---|---|---|---|
| Co-propagating | −60 | −60 | −56.85 | −56.85 |
| cross talk at 1310 | | | | |
| nm (1 m length) | | | | |
| (dB) | | | | |
| Co-propagating | −50 | −50 | −46.85 | −46.85 |
| cross talk at 1310 | | | | |
| nm (10 m length) | | | | |
| (dB) | | | | |
| Co-propagating | −47 | −47 | −43.84 | −43.84 |
| cross talk at 1310 | | | | |
| nm (20 m length) | | | | |
| (dB) | | | | |
| Co-propagating | −40 | −40 | −36.85 | −36.85 |
| cross talk at 1310 | | | | |
| nm (100 m length) | | | | |
| (dB) | | | | |
| Co-propagating | −30 | −30 | −26.9 | −26.9 |
| cross talk at 1310 | | | | |
| nm (1000 m length) | | | | |
| (dB) | | | | |
| Co-propagating | −39.5 | −39.5 | −−36.82 | −36.82 |
| cross talk at 1550 | | | | |
| nm (1 m length) | | | | |
| (dB) | | | | |
| Co-propagating | −29.5 | −29.5 | −26.82 | −26.82 |
| cross talk at 1550 | | | | |
| nm (10 m length) | | | | |
| (dB) | | | | |
| Co-propagating | −26.5 | −26.5 | −23.81 | −23.81 |
| cross talk at 1550 | | | | |
| nm (20 m length) | | | | |
| (dB) | | | | |
| Co-propagating | −19.5 | −19.5 | −16.82 | −16.82 |
| cross talk at 1550 | | | | |
| nm (100 m length) | | | | |
| (dB) | | | | |
| Co-propagating | −9.5 | −9.5 | −6.82 | −6.82 |
| cross talk at 1550 | | | | |
| nm (1000 m length) | | | | |
| (dB) | | | | |

TABLE 5A

| | Ex. 1 | Ex. 2 | Ex. 3 | Ex. 4 |
|---|---|---|---|---|
| Counter- | −83.2 | −83.2 | −78.94 | −78.94 |
| propagating cross | | | | |
| talk at 1310 nm | | | | |
| (1 m length) (dB) | | | | |
| Counter- | −73.2 | −73.2 | −68.93 | −68.93 |
| propagating cross | | | | |
| talk at 1310 nm | | | | |
| (10 m length) (dB) | | | | |
| Counter- | −70.2 | −70.2 | −65.91 | −65.91 |
| propagating cross | | | | |
| talk at 1310 nm | | | | |
| (20 m length) (dB) | | | | |
| Counter- | −63.1 | −63.1 | −58.84 | −58.84 |
| propagating cross | | | | |
| talk at 1310 nm | | | | |
| (100 m length) (dB) | | | | |
| Counter- | −53 | −53 | −48.07 | −48.07 |
| propagating cross | | | | |
| talk at 1310 nm | | | | |
| (1000 m length) (dB) | | | | |
| Counter- | −62.7 | −62.7 | −59.27 | −59.27 |
| propagating cross | | | | |
| talk at 1550 nm | | | | |
| (1 m length) (dB) | | | | |
| Counter- | −52.3 | −52.3 | −48.47 | −48.47 |
| propagating cross | | | | |
| talk at 1550 nm | | | | |
| (10 m length) (dB) | | | | |
| Counter- | −48.84 | −48.84 | −44.72 | −44.72 |
| propagating cross | | | | |
| talk at 1550 nm | | | | |
| (20 m length) (dB) | | | | |
| Counter- | −39.6 | −39.6 | −34.2 | −34.2 |
| propagating cross | | | | |
| talk at 1550 nm | | | | |
| (100 m length) (dB) | | | | |
| Counter- | −22.1 | −22.1 | −15.59 | −15.59 |
| propagating cross | | | | |
| talk at 1550 nm | | | | |
| (1000 m length) (dB) | | | | |

TABLE 5B

| | Ex. 5 | Ex. 6 | Ex. 7 | Ex. 8 |
|---|---|---|---|---|
| Counter- | −78.46 | −78.46 | −87.50 | −87.50 |
| propagating cross | | | | |
| talk at 1310 nm | | | | |
| (1 m length) (dB) | | | | |
| Counter- | −68.45 | −68.45 | −77.50 | −77.50 |
| propagating cross | | | | |
| talk at 1310 nm | | | | |
| (10 m length) (dB) | | | | |
| Counter- | −65.43 | −65.43 | −74.50 | −74.50 |
| propagating cross | | | | |
| talk at 1310 nm | | | | |
| (20 m length) (dB) | | | | |
| Counter- | −58.36 | −58.36 | −67.50 | −67.50 |
| propagating cross | | | | |
| talk at 1310 nm | | | | |
| (100 m length) (dB) | | | | |
| Counter- | −47.49 | −47.49 | −57.49 | −57.49 |
| propagating cross | | | | |
| talk at 1310 nm | | | | |
| (1000 m length) (dB) | | | | |
| Counter- | −58.77 | −58.77 | −66.52 | −66.52 |
| propagating cross | | | | |
| talk at 1550 nm | | | | |
| (1 m length) (dB) | | | | |
| Counter- | −47.89 | −47.89 | −56.35 | −56.35 |
| propagating cross | | | | |
| talk at 1550 nm | | | | |
| (10 m length) (dB) | | | | |
| Counter- | −44.07 | −44.07 | −53.17 | −53.17 |
| propagating cross | | | | |
| talk at 1550 nm | | | | |
| (20 m length) (dB) | | | | |
| Counter- | −33.31 | −33.31 | −44.97 | −44.97 |
| propagating cross | | | | |
| talk at 1550 nm | | | | |
| (100 m length) (dB) | | | | |
| Counter- | −14.62 | −14.62 | −29.24 | −29.24 |
| propagating cross | | | | |
| talk at 1550 nm | | | | |
| (1000 m length) (dB) | | | | |

TABLE 5C

| | Ex. 9 | Ex. 10 | Ex. 11 | Ex. 12 |
|---|---|---|---|---|
| Counter- | −−83 | −83 | −79.89 | −79.89 |
| propagating cross | | | | |
| talk at 1310 nm | | | | |
| (1 m length) (dB) | | | | |
| Counter- | −73 | −73 | −69.88 | −69.88 |
| propagating cross | | | | |
| talk at 1310 nm | | | | |
| (10 m length) (dB) | | | | |
| Counter- | −70 | −70 | −66.87 | −66.87 |
| propagating cross | | | | |
| talk at 1310 nm | | | | |
| (20 m length) (dB) | | | | |
| Counter- | −−63 | −63 | −59.82 | −59.82 |
| propagating cross | | | | |
| talk at 1310 nm | | | | |
| (100 m length) (dB) | | | | |
| Counter- | −53 | −53 | −49.27 | −49.27 |
| propagating cross | | | | |
| talk at 1310 nm | | | | |
| (1000 m length) (dB) | | | | |
| Counter- | −62.5 | −62.5 | −66.52 | −66.52 |
| propagating cross | | | | |
| talk at 1550 nm | | | | |
| (1 m length) (dB) | | | | |
| Counter- | −52.1 | −52.1 | −59.72 | −59.72 |
| propagating cross | | | | |
| talk at 1550 nm | | | | |
| (10 m length) (dB) | | | | |
| Counter- | −48.6 | −48.6 | −48.99 | −48.99 |
| propagating cross | | | | |
| talk at 1550 nm | | | | |
| (20 m length) (dB) | | | | |
| Counter- | −39.4 | −39.4 | −45.29 | −45.29 |
| propagating cross | | | | |
| talk at 1550 nm | | | | |
| (100 m length) (dB) | | | | |
| Counter- | −21.1 | −21.1 | −34.94 | −34.64 |
| propagating cross | | | | |
| talk at 1550 nm | | | | |
| (1000 m length) (dB) | | | | |

As indicated in Tables 4A-4C and 5A-5C, the waveguides of the modeled multicore optical fibers had relatively low co-propagating and counter-propagating inter-waveguide cross talk at wavelengths of 1310 nm and 1550 nm for fiber lengths from 1 m to 1000 meters. The data in Tables 4A-4C and 5A-5C indicate that a plurality of waveguides having the designs indicated in Table 1 can be incorporated into a common cladding with a standardized diameter (i.e., 2R₄) while still obtaining relatively low co-propagating and counter-propagating inter-waveguide cross talk values such that the multicore optical fibers can be utilized in harnesses in co-packaged optic applications in electronic devices without diminishing the integrity of the optical signals propagating in the waveguides of the multicore optical fibers due to cross talk.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A multicore optical fiber comprising:
a common cladding comprising a radius R₄ defining a glass portion of the multicore optical fiber and having a common cladding relative refractive index Δ₄;
at least two waveguides extending through the common cladding, each of the at least two waveguides comprising a core region, an inner cladding region encircling and directly contacting the core region, and a depressed cladding region encircling and directly contacting the inner cladding region, wherein:
the common cladding surrounds and directly contacts the depressed cladding region of each of the at least two waveguides;
the radius R₄ of the common cladding is greater than or equal to 37.5 μm and less than or equal to 65 μm;
the core region of each of the at least two waveguides comprises a core maximum relative refractive index Δ₁ₘₐₓ relative to pure silica glass;
the inner cladding region of each of the at least two waveguides comprises an inner cladding relative refractive index Δ₂ relative to pure silica glass;
the depressed cladding region of each of the at least two waveguides comprises a minimum depressed relative refractive index Δ₃ₘᵢₙ relative to pure silica glass and a trench volume V_{T} greater than or equal to 20% μm² and less than or equal to 45% μm²;
$${Δ}_{1 max} > {Δ}_{2} > {Δ}_{3 min} , and {Δ}_{4} > {Δ}_{3 min} ;$$
a cable cutoff wavelength of each of the at least two waveguides is less than or equal to 1150 nm;
a co-propagating inter-waveguide cross talk between each of the at least two waveguides and a nearest neighbor of each waveguide is less than −35 dB at 1310 nm and less than −20 dB at 1550 nm for application lengths of 20 m;
a counter-propagating inter-waveguide cross talk between each of the at least two waveguides and a nearest neighbor of each waveguide are less than −35 dB at 1310 nm and less than −20 dB at 1550 nm for application lengths of 20 m; and
a mode field diameter of each of the at least two waveguides is greater than or equal to 8.2 μm and less than or equal to 9.0 μm at 1310 nm.

2. The multicore optical fiber of claim 1, wherein each waveguide of the at least two waveguides comprises a zero dispersion wavelength greater than or equal to 1300 nm and less than or equal to 1324 nm.

3. The multicore optical fiber of claim 1, wherein an attenuation of the at least two waveguides of the multicore optical fiber is less than 0.55 dB/km at a wavelength of 1310 nm.

4. The multicore optical fiber of claim 1, wherein a macrobend loss of each waveguide of the at least two waveguides is less than or equal to 0.05 dB/turn around a 15 mm diameter mandrel at a wavelength of 1310 nm.

5. The multicore optical fiber of claim 1, wherein a macrobend loss of each waveguide of the at least two waveguides is less than or equal to 0.7 dB/turn around a 15 mm diameter mandrel at a wavelength of 1550 nm.

6. The multicore optical fiber of claim 1, wherein a waveguide-to-waveguide separation distance between each waveguide of the at least two waveguides and a nearest neighbor of each waveguide is greater than or equal to 25 μm and less than or equal to 33 μm.

7. The multicore optical fiber of claim 1, wherein a web spacing between each waveguide of the at least two waveguides and a nearest neighbor of each waveguide is greater than or equal to 1.5 μm.

8. The multicore optical fiber of claim 1, wherein an edge of each waveguide of the at least two waveguides is separated from an outer surface of the common cladding by a minimum waveguide edge to glass distance of greater than or equal to 8 μm.

9. The multicore optical fiber of claim 1, wherein a length of the multicore optical fiber is greater than or equal to 0.5 m and less than or equal to 5 m.

10. The multicore optical fiber of claim 1, wherein the radius R₄ is greater than or equal to 39 μm and less than or equal to 40 μm and the at least two waveguides is two waveguides.

11. The multicore optical fiber of claim 1, wherein the radius R₄ is greater than or equal to 62 μm and less than or equal to 63 μm and the at least two waveguides is four waveguides arranged in a 1×4 array.

12. The multicore optical fiber of claim 1, wherein the core region of each waveguide of the at least two waveguides comprises a radius r₁ greater than or equal to 3.5 μm and less than or equal to 5 μm.

13. The multicore optical fiber of claim 1, wherein the core maximum relative refractive index Δ₁ₘₐₓ of the core region of each waveguide of the at least two waveguides is greater than or equal to 0.30% and less than or equal to 0.40%.

14. The multicore optical fiber of claim 1, wherein the core region of each waveguide of the at least two waveguides is free of optically active materials.

15. The multicore optical fiber of claim 1, wherein the inner cladding region of each waveguide of the at least two waveguides comprises a radial thickness t₂ greater than or equal to 2 μm and less than or equal to 6.5 μm.

16. The multicore optical fiber of claim 1, wherein the inner cladding relative refractive index Δ₂ of each waveguide of the at least two waveguides is greater than or equal to −0.05% and less than or equal to 0.05%.

17. The multicore optical fiber of claim 1, wherein the depressed cladding region of each waveguide of the at least two waveguides comprises a radial thickness t₃ greater than 0 μm and less than or equal to 6.5 μm.

18. The multicore optical fiber of claim 1, wherein the minimum depressed relative refractive index Δ₃ₘᵢₙ of each waveguide of the at least two waveguides is less than or equal to −0.20% and greater than or equal to −1%.

19. An electronic device comprising:
a processor circuit board comprising an application specific integrated circuit communicatively coupled to a plurality of co-packaged optical transceiver chips, wherein each co-packaged optical transceiver chip of the plurality of co-packaged optical transceiver chips comprises at least two input/output channels; and
a multicore optical fiber of claim 1 optically coupled to each co-packaged optical transceiver chip at a first end of the multicore optical fiber, wherein each of the at least two waveguides of the multicore optical fiber is optically coupled to a corresponding input/output channel of the at least two input/output channels of each co-packaged optical transceiver chip.

20. The electronic device of claim 19, wherein the electronic device comprises a shore density of greater than or equal to 1 Tbps/mm at a die edge of the processor circuit board.
